(19) United States
(12) Patent Application Publication
(10) Pub. No.: US 2004/0199805 A1
(43) Pub. Date: Oct. 7, 2004

(54) Repair worker assisting method, repair worker assisting program, repair worker assisting system, and terminal

(75) Inventor: Masaru Yasunaga, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/803,123

(22) Filed: Mar. 18, 2004

(30) Foreign Application Priority Data
Apr. 3, 2003 (JP) 2003-100172

(51) Int. Cl. H02H 3/05

(52) U.S. Cl. 714/2

(57) ABSTRACT

A repair worker assisting method for assisting a repair worker who visits a customer's residence to perform maintenance of equipment, the method includes the steps of instructing to deliver a component for replacement upon receiving a request from the customer; and notifying the repair worker that a repair work is ready to start upon having accepted the customer's payment for the component.

### BACKGROUND OF THE INVENTION

The present invention relates to a method, a program, a system, and a terminal which serve to repair equipment such as a computer and electrical/mechanical products in the event of failure.

As personal computers (hereinafter, referred to as “PCs”) and various electrical/mechanical products become wide spread, demand for maintenance of those equipment has also been growing. Methods for the maintenance include a method in which a customer carries equipment requiring maintenance into a store from which he/she bought the equipment or into a maker thereof and requests repair, and a method in which a person from the maker or a dedicated maintenance company visits customer's residence and performs the repair.

Hereinafter, a conventional on-site repair method will be described. FIG. 1 shows a conceptual diagram of a conventional on-site repair system 201.

In many cases where a customer requests on-site repair, a customer 202 makes inquiries to an on-site repair reception center 203 that is sponsored by a PC maker or a dedicated repairer.

When the customer makes inquiries about failure conditions by phone, e-mail, or the like, an operator serves him/her. The operator determines the kind and number of a component required for repair based on the failure conditions, and places an order with a component maker (warehouse).

Also, the operator judges whether or not a repair worker (repairer; maintenance personnel) who performs repair needs to be dispatched based on the failure conditions. In the case of judging that the repair worker needs to be dispatched, selection is made for the repair worker required for the repair. The selection of the worker required is made in a station (on-site repair station) 205 that is located for each area and dispatches repair workers. As the station here, a station nearest to a customer's (that is, client's) residence is selected.

In addition, the repair worker selected here is a repair worker who can handle failure contents and has much time left in his/her schedule of on-site service.

Meanwhile, the ordered component is transported to the station by a transporter 204. Then, the selected repair worker visits the customer's residence with the ordered component.

After completion of the repair, the repair worker charges the customer for the repair in cash (cash on delivery). That is, in the conventional on-site repair, the customer pays a repair fee for the completed repair.

[Patent document 1]

JP 2001-306360 A

[Patent document 2]

JP 2002-109097 A

[Patent document 3]

JP 2002-73855 A

However, some customers are reluctant to pay in cash on the spot. Such a case may be solved by taking the repaired equipment into the repair worker's keeping until the customer pays the repair fee.

However, with the repaired equipment being at the customer's residence, it is difficult for the repair worker to take the repaired equipment into his/her keeping until payment.

In this view, a method is conceivable of having the customer pay the repair fee into a financial institute specified by the repairer.

However, such collection of the repair fee after repair is often performed based on the customer's credibility. Thus, there are some cases where it is difficult to collect the repair fee with reliability.

Further, in the case of receiving a sudden request from a customer who is not involved in a series of schedule of on-site service on the date, the repair worker must go back to the component maker or the component warehouse to fetch a component for repair. In such a case, the repair worker having much time left can fetch the component before visiting the customer's residence. However, if the repair worker has no time left, there are only two options that another repair worker pays a visit instead and that the same repair worker pays a visit at another date and time.

### SUMMARY OF THE INVENTION

The present invention has been made in view of the circumstances, and therefore has an object to provide a repair worker assisting method, a repair worker assisting program, a repair worker assisting system, and a terminal, which are capable of improving a collection rate for repair fees from customers.

Further, the present invention has an object to provide a repair worker assisting method, a repair worker assisting program, a storage medium storing the program, a repair worker assisting system, and a terminal, which are capable of performing on-site repair tasks with high efficiency and flexibility.

The present invention employs the following means (units) to achieve the objects. That is, the present invention relates to a method of assisting a repair worker who visits a customer's residence to perform maintenance of equipment, the method being characterized by including: a step of instructing to deliver a component for replacement upon receiving a request from the customer; and a step of notifying the repair worker that a repair work is ready to start upon having accepted the customer's payment for the component. Note that examples of the customer according to the present invention may include an individual user who owns (uses) the equipment and a company and a store who deal in the equipment.

Specifically, a repair worker assisting method according to the present invention is characterized by including: a step of receiving repair content data inputted from a terminal (apparatus) of a customer; a step of calculating a repair fee based on the repair content data; a step of judging whether or not a repair component is necessary based on the repair content data; a step of, upon judging that the repair component is necessary in the preceding step, notifying a terminal on a side of a deliverer who delivers the repair component of an instruction for delivering the repair component to the customer; a step of, after delivering the repair component to the customer, receiving a notification of completion of delivery from the deliverer; a step of, upon receiving the notification, notifying the terminal of the customer of billing of the repair fee; a step of, after the customer has paid the repair fee into a predetermined financial institute, receiving a notification of completion of payment from a terminal on a side of the financial institute; and a step of, upon receiving the notification of completion of payment, instructing to dispatch a repair worker to the customer's residence.

As described above, according to the present invention, the component is handed over as a condition for the payment of the repair fee. Accordingly, a collection rate for repair fees from customers can be improved.

Further, a repair worker assisting method according to the present invention may include: a step of receiving an input of address data of the customer's residence; a step of referencing map data containing a position of a station located for each area; and a step of extracting an appropriate station based on the address data.

Accordingly, such inefficient progress in maintenance tasks is extremely rarely made as in the case where a maintenance person is dispatched from a station located far away from the customer.

Further, a repair worker assisting method according to the present invention may include: a step of receiving an instruction for dispatching a repair worker from a server that assists dispatch of a repair worker who performs a maintenance task; a step of referencing a database that serves to manage a current location of the repair worker; a step of extracting an appropriate repair worker based on address data of a customer's residence to be visited; and a step of notifying a mobile terminal owned by the repair worker of a dispatch instruction.

Accordingly, it is possible that even the repair worker on the move accepts a sudden dispatch instruction, if it suits his/her convenience, and performs a maintenance task without wasting time.

Further, a repair worker assisting method according to the present invention may be adapted to include: a step of receiving an instruction for dispatching a repair worker from the server; a step of referencing a database that serves to manage a scheduled visit number for each repair worker and an assigned number of repair workers for each area; a step of calculating an average number of visits in charge per repair worker from the scheduled visit number and the assigned number of workers; and a step of issuing a dispatch instruction in order from the repair workers in an area with a small average number of visits in charge per repair worker.

Accordingly, an imbalance among the numbers of the visits in charge per repair worker can be prevented. Simultaneously, an imbalance among the numbers of the visits in charge per area can also be prevented.

Further, a repair worker assisting method according to the present invention may include a step of, based on a location of the repair worker, a location of the customer's residence to be visited, and predetermined conditions, retrieving a route to the customer's residence in a chronological order for the visit time.

Further, a repair worker assisting method according to the present invention may be adapted to include a step of, in the case where it is impossible to be in time for the visit time with a calculated route, issuing from a terminal of a maintenance company an instruction for requesting an adjacent station to issue a dispatch instruction.

Such adaptation enables efficient performance of the maintenance tasks.

Further, a terminal at a station according to the present invention includes a database storing a schedule assigned to each repair worker, and preferably includes a unit that extracts a repair worker having much time left in his/her schedule based on data stored in the database upon receiving a sudden request for on-site repair from a customer.

When the repair worker accepts the sudden on-site repair, the terminal at a station includes a unit that reconstructs the schedule of on-site service assigned to the repair worker based on a destination location and a visit date and time.

As described above, the present invention is adapted to handle an irregular request for on-site repair by sliding a repair worker having much time left for such a request in his/her schedule. Accordingly, it is possible to promptly handle the case of sudden cancellation of on-site repair or the sudden request for on-site repair.

Further, the present invention also provides a program and a storage medium storing the program executed by a server that assists dispatch of a repair worker who performs a maintenance task upon receiving a request for maintenance from a terminal.

In addition, a repair worker assisting program according to the present invention includes: a step of receiving repair content data inputted from a terminal of a customer; a step of calculating a repair fee based on the repair content data; a step of judging whether or not a repair component is necessary based on the repair content data; a step of, upon judging that the repair component is necessary, notifying a terminal on a side of a deliverer who delivers the repair component of an instruction for delivering the repair component to the customer; a step of, after delivering the repair component to the customer, receiving a notification of completion of delivery from the deliverer; a step of, upon receiving the notification, notifying the terminal of the customer of billing of the repair fee; a step of, after the customer has paid the repair fee into a predetermined financial institute, receiving a notification of completion of payment from a terminal on a side of the financial institute; and a step of, upon receiving the notification of completion of payment, instructing to dispatch a repair worker to the customer's residence.

Further, the present invention also provides a system that assists dispatch of a repair worker who visits a customer's residence to perform a maintenance task upon receiving a request for maintenance from a terminal.

A repair worker assisting system according to the present invention is characterized by including: means that receives repair content data inputted from a terminal; means that calculates a repair fee based on the repair content data; means that judges whether or not a repair component is necessary based on the repair content data; means that, upon judging that the repair component is necessary, notifies a terminal on a side of a deliverer who delivers the repair component of an instruction for delivering the repair component to a customer; means that, after delivering the repair component to the customer, receives a notification of completion of delivery from the deliverer; means that, upon receiving the notification, notifies the terminal of the customer of billing of the repair fee; means that, after the customer has paid the repair fee into a predetermined financial institute, receives a notification of completion of payment from a terminal on a side of the financial institute; and means that, upon receiving the notification of completion of payment, issues an instruction for dispatching a repair worker to the customer's residence.

Further, the present invention also provides a terminal including: means that receives an instruction for dispatching a repair worker from a server that assists dispatch of a repair worker who performs maintenance tasks upon receiving a request for maintenance from a terminal; means that references a database that serves to manage a current location of the repair worker; means that extracts an appropriate repair worker based on address data of a customer's residence to be visited; and means that notifies a mobile terminal owned by the repair worker of a dispatch instruction. The terminal is preferably a terminal of a repairer who manages a repair worker.

Alternatively, according to the present invention, there may be provided a terminal including: means that receives an order for a component from a server that places an order for a component upon receiving a request for maintenance from a terminal of a customer; means that references a database that serves to manage a current location of a delivery person who delivers a component; means that extracts an appropriate delivery person based on address data of a customer's residence to be visited; and means that notifies a mobile terminal owned by the delivery person of a delivery instruction.

### DESCRIPTION OF THE DRAWINGS

FIG. 1 is a diagram showing a conventional flow of an on-site service instruction, a component, and money.

FIG. 2 is a conceptual diagram of a repair worker assisting system according to the embodiment.

FIGS. 3A and 3B are detailed conceptual diagrams of a repair worker assisting system according to the embodiment.

FIG. 4 is a conceptual diagram of a customer-inquiry reception database according to the embodiment.

FIG. 5 is a conceptual diagram of a reference database according to the embodiment.

FIG. 6 is a conceptual diagram of an on-site service database according to the embodiment.

FIG. 7 is a conceptual diagram of the on-site service database according to the embodiment.

FIG. 8 is an example of a data entry display for on-site repair reception according to the embodiment.

FIG. 9 is an example of the data entry display for on-site repair reception according to the embodiment.

FIG. 10 is an example of a data entry display for home-delivery reception according to the embodiment.

FIG. 11 is an example of a display for an instruction/report form for on-site repair according to the embodiment.

FIG. 12 is an example of the display for the instruction/report from for on-site repair according to the embodiment.

FIG. 13 is an example of the display for the instruction/report form for on-site repair according to the embodiment.

FIG. 14 is a flow chart of a repair worker assisting method according to the embodiment.

FIG. 15 is a flow chart of the repair worker assisting method according to the embodiment.

FIG. 16 is a flow chart of the repair worker assisting method according to the embodiment.

FIG. 17 is a flow chart of a sequence of automatically preparing on-site repair schedule at a station in charge of on-site repair according to the embodiment.

FIG. 18 is a flow chart of the a sequence of automatically preparing on-site repair schedule at the station in charge of on-site repair according to the embodiment.

FIG. 19 is a flow chart upon interrupt request for on-site repair according to the embodiment.

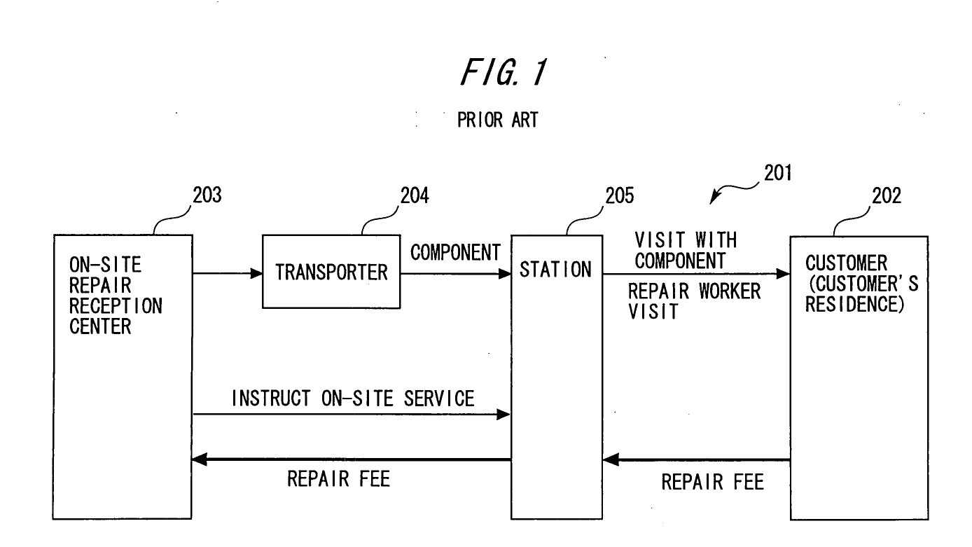

### DETAILED DESCRIPTION OF THE INVENTION

Hereinafter description will be made of a repair worker assisting method and a repair worker assisting system according to an embodiment.

<System Concept>

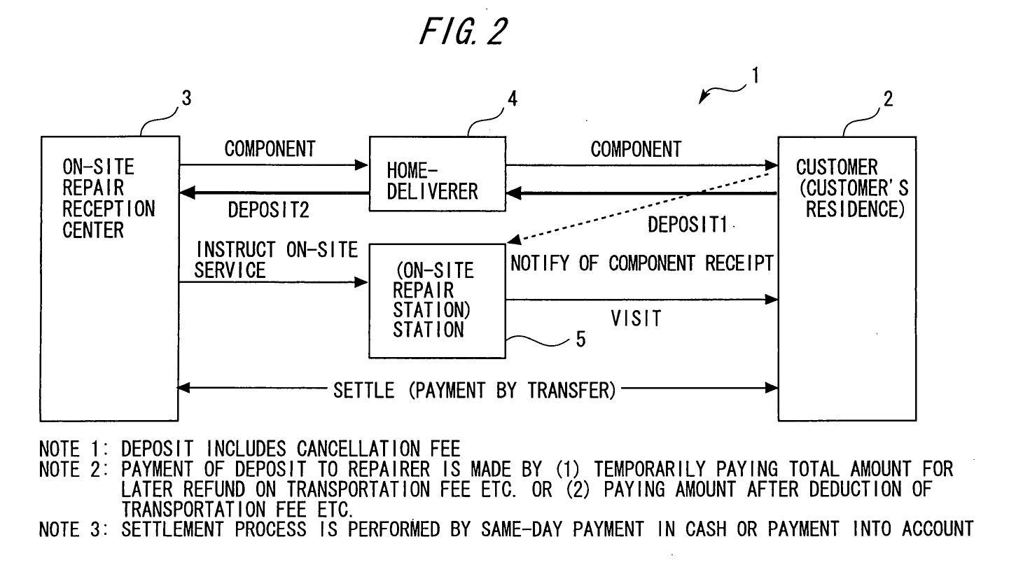

FIG. 2 shows a conceptual diagram of the repair worker assisting system according to the embodiment. A repair worker assisting system 1 according to the embodiment includes an on-site repair reception center 3 that receives a repair request for equipment from a customer 2, a home-deliverer 4 who home-delivers a repair component to a customer's residence, and a station (on-site repair station) 5 from which a repair worker is dispatched.

Upon receiving the repair request for equipment from the customer 2, the on-site repair reception center 3 prepares a component from a component warehouse, and requests the home-deliverer 4 to home-deliver the component.

When the home-deliverer 4 delivers the component to the customer's residence 2, the customer 2 sends a receipt notification for the component to the station.

Also, the customer 2 pays a repair fee including a component price and a deposit including a cancellation fee to the home-deliverer 4 in exchange for receipt of the component. The payment method is preferably the payment in cash to the home-deliverer 4 on the spot. However, the payment method may be the payment into a predetermined account of the home-deliverer 4 at a financial institute 6.

The home-deliverer 4 who has received the deposit transfers the deposit to the on-site repair reception center 3. The transfer methods include a method in which the total amount of the deposit paid by the customer 2 is transferred, and a transportation fee and a commission on the home-deliverer 4 are paid from the on-site repair reception center 3, and a method in which the home-deliverer 4 pays to the on-site repair reception center 3 the amount with the transportation fee and the commission deducted by the home-deliverer 4 in advance.

The on-site repair reception center 3 that has received the deposit issues an instruction for dispatching a repair worker to the on-site repair station 5.

Upon receiving the instruction for dispatching a repair worker, the on-site repair station 5 selects an appropriate repair worker, and issues an instruction for visiting the customer's residence 2 to perform maintenance.

Upon completion of the repair, a settlement process for the repair fee is performed between the customer 2 and the on-site repair reception center 3. The settlement process is performed for adjusting a difference between the repair fee that has been paid and the repair fee that has been actually required for the repair. This is because the repair fee that has been paid is the amount based on an estimate prepared by the on-site repair reception center 3. Note that similarly to the above payment methods, the settlement method may be the payment in cash or may be the payment into a predetermined account of the on-site repair reception center 3 at a financial institute 6.

Accordingly, by employing the arrangement in which the component is sent to the customer 2 in advance and pays the repair fee in exchange for the component, the repair fees, which have been difficult to completely collect, can be collected with a high rate.

Described above is the outline of the repair worker assisting system 1.

<Hardware Configuration>

Next, the repair worker assisting system 1 according to the embodiment will be described in detail.

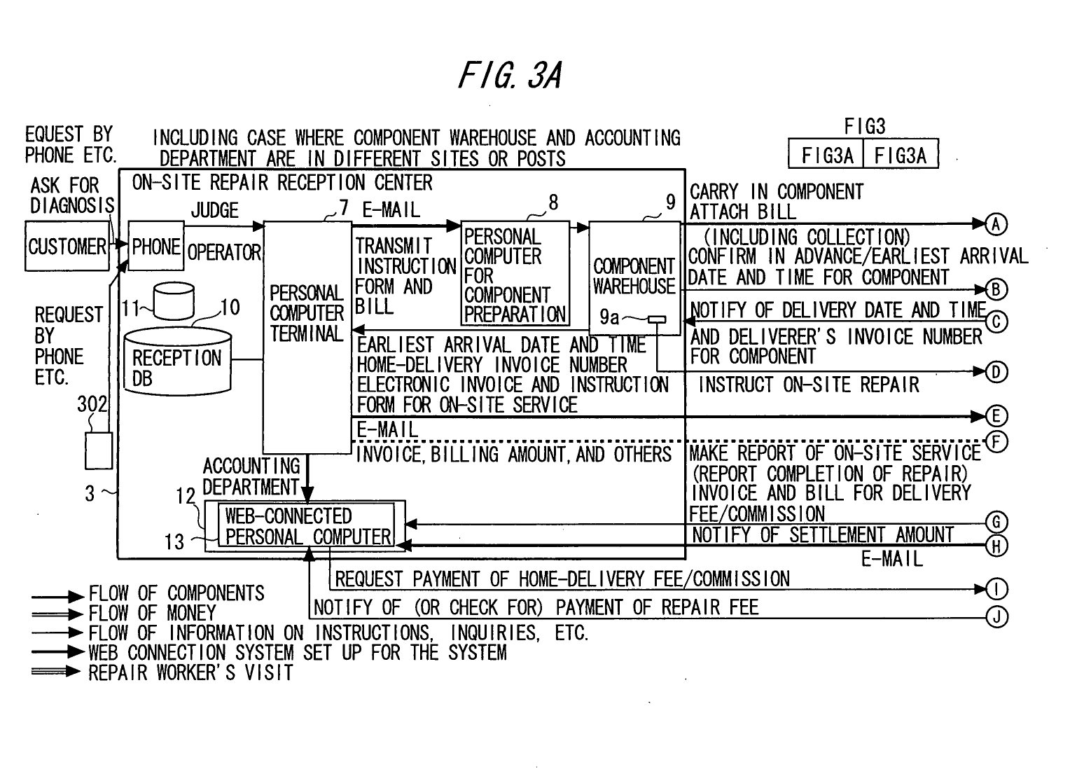

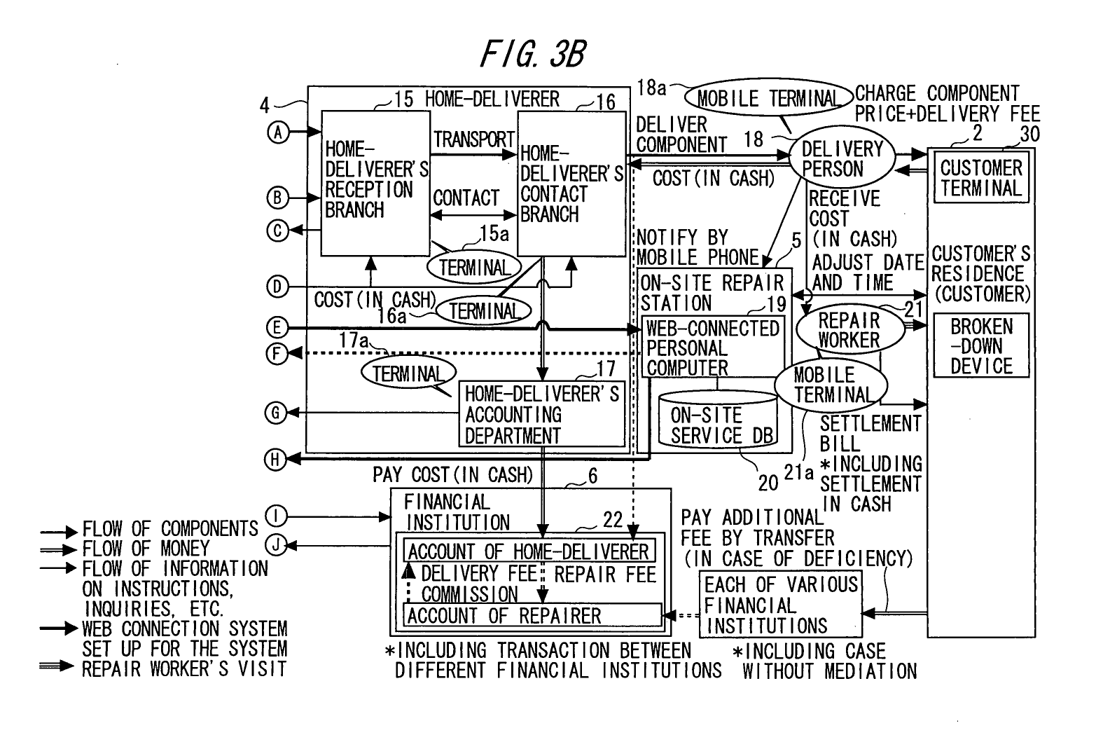

FIG. 3 shows a detailed system conceptual diagram of the repair worker assisting system 1 according to the embodiment.

The repair worker assisting system 1 according to the embodiment is managed by: a customer 2 (customer terminal 30) from which an inquiry for maintenance is made; an on-site repair reception center 3 where the inquiry for the maintenance from the customer 2 is received; a home-deliverer 4 who delivers a component necessary for the repair requested from the on-site repair reception center 3 to the customer's residence 2; an on-site repair station 5 that dispatches a repair worker (repairer) for performing the repair; and a financial institution 6 that mediates the repair fee paid by the customer 2 between the home-deliverer 4 and the on-site repair reception center 3.

The customer 2 has a broken-down device that needs maintenance. Further, the customer 2 has the customer terminal 30 that can be connected to the internet. The customer 2 exchanges information with the on-site repair reception center 3, the home-deliverer 4, the on-site repair station 5, and the financial institution 6 through the customer terminal 30.

Note that the customer 2 can make the inquiry for the broken-down device by directly calling an operator at the on-site repair reception center 3, or by sending out an e-mail from the customer terminal 30.

The on-site repair reception center 3 has: a PC terminal 7 for receiving the inquiry from the customer 2 and instructing placement of order for the necessary component and dispatch of the repair worker; a PC for component preparation system 8 for arranging placement of order for and delivery of the component necessary for the repair; and a component warehouse 9 provided with a terminal 9a for managing components.

The PC terminal 7 includes a customer-inquiry reception database 10 for storing inquiry data from the customer 2 and a reference database 11 for storing various data to be referenced in placing order for a component, selecting a station, and the like. The data stored in those databases will be described later.

Further, the on-site repair reception center 3 includes an accounting department 12 that performs processes involving payment of a repair fee, a home-delivery request fee, and the like. The account department 12 has a Web-connected PC 13 for communicating with the outside, e.g., the terminal of the home-deliverer 4, the computer 22 of the financial institution, and the like in order to conduct maintenance tasks. Note that each of the terminals is an existing personal computer provided with a CPU for controlling the terminal, a ROM for storing a program for executing basic control, a RAM for temporarily storing the contents of the control, communication means which allows communication among the terminals, a hard disk for storing various data, a customer interface for inputting the various data, and the like. Thus, detailed description thereof is omitted.

The home-deliverer 4 is composed of: a home-deliverer's reception branch 15 provided with a terminal 15 for receiving a home-delivery instruction; a home-deliverer's delivery branch 16 that receives a delivery instruction from the home-deliverer's reception branch 15; and a home-deliverer's accounting department 17 that performs processes involving billing and payment for home-delivery tasks. Note that the home-deliverer's reception branch 15, the home-deliverer's delivery branch 16, and the home-deliverer's accounting department 17 have terminals 15a, 16a, and 17a, respectively.

Further, the term “home-deliverer 4” includes a delivery person 18 who actually delivers a component. The delivery person 18 carries a mobile terminal 18a such as a mobile phone even while on delivery so that he/she can receive instructions from the home-deliverer 4 when performing home-delivery tasks.

Further, the on-site repair station 5 has the Web-connected PC 19 for communicating with the on-site repair reception center 3, the home-deliverer 4, the financial institution 6, and the customer 2. Note that the structure of the Web-connected PC 19 is the same as that of the existing PC and thus, description thereof is omitted.

As an alternate structure, the Web-connected PC 19 is provided with an on-site service database 20 for storing data necessary for performing on-site service at the customer's residence 2 that has a request for maintenance. The data stored in the on-site service database 20 is the similar kind of data stored in the customer-inquiry reception database 10 and the reference database 11.

Further, the on-site repair station 5 also serves as a station for the repair worker 21 who actually visits the customer's residence and repairs the broken-down equipment. The repair worker, similarly to the delivery person, carries a mobile terminal 21a such as a mobile phone, PHS (Personal Handy phone System), PDA (Personal Digital Assistant), or the like so that he/she can respond to emergency contact and an interrupting on-site service request from the on-site repair station 5 while moving or performing on-site service.

Further, in the embodiment, the repairer (company that manages repair workers), the on-site repair reception center 3, and the on-site repair station 5 are described as the same company. Of course they may be separate companies. Further, the repairer managed at the on-site repair station 5 may be inside or outside the on-site repair station 5.

The financial institution 6 has a computer 22 for performing processes related to accounts of the home-deliverer 4 and the repair company. The customer 2 pays a portion of the repair fee into the account of the home-deliverer 4 upon reception of the component at the customer's residence 2. Note that the portion of the repair fee preferably includes at least the component price. Further, upon completion of the repair, the customer pays the remaining of the repair fee into a predetermined account of the on-site repair reception center 3. Note that various financial institutions may intervene between the customer 2 and the financial institution 6. For example, the customer 2 may pay or settle the repair fee through the account of the customer 2. In this case, the repair fee is paid from a predetermined financial institution 6 that the customer 2 uses to a financial institution 6 designated by the on-site repair reception center 3, thereby being paid to the on-site repair reception center 3.

<Data Structure>

Next, description will be made of various data corresponding to a customer 2 stored in the customer-inquiry reception database 10 and the reference database 11, which are provided to the PC terminal 7 of the on-site repair reception center 3.

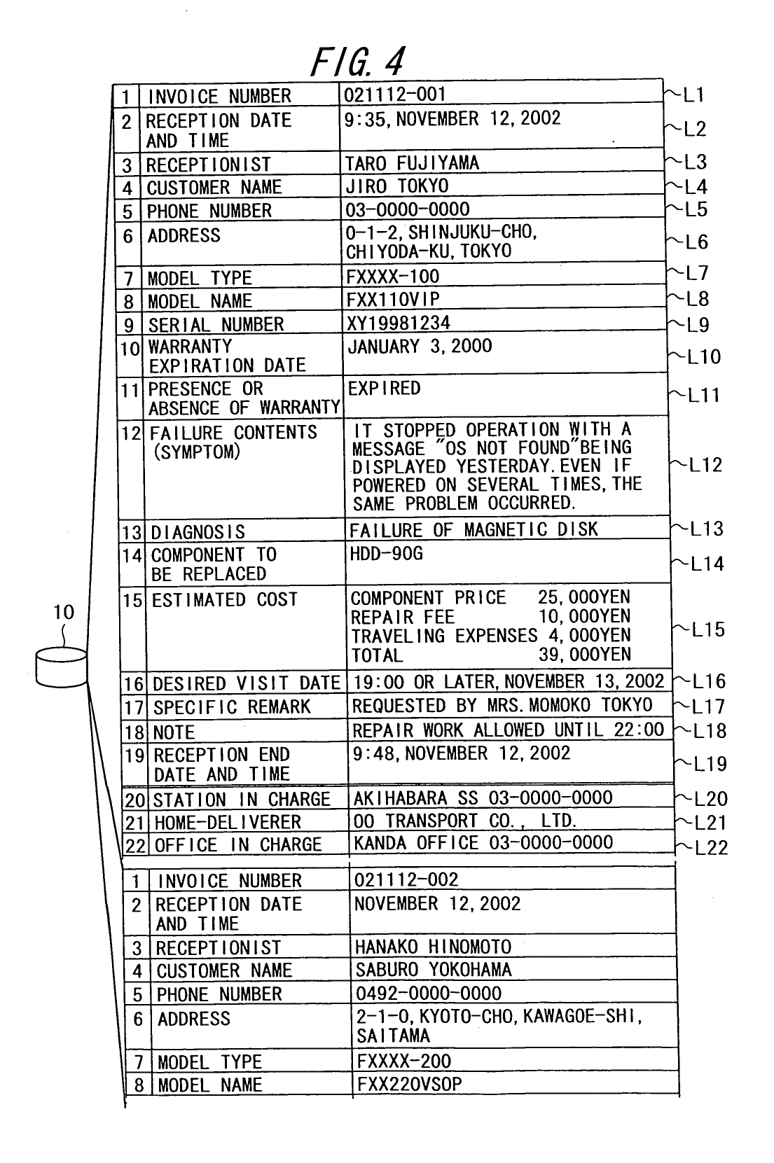

FIG. 4 shows a list of data stored in the customer-inquiry reception database 10. Items 1 to 22 are inputted for each inquiry. A first item L1 is an invoice number. The invoice number is automatically assigned to each inquiry from a customer 2 in the order of reception. A second item L2 is a reception date and time of the inquiry from the customer 2. A third item L3 is the name of an operator who received the inquiry. A fourth item L4 is the name of a customer 2 who made the inquiry. A fifth item L5 is a phone number of the customer 2. A sixth item L6 is an address of the customer 2. A seventh item L7 is a model type of the device requiring repair. An eighth item L8 is a model name of the device requiring repair. A ninth item L9 is a serial number of the device requiring repair. A tenth item L10 is warranty expiration (date) for the device requiring repair. An eleventh item L11 is presence or absence of a warranty for the device requiring repair.

Further, a twelfth item L12 is failure contents (symptom). The failure contents may be inputted in sentences or lists. A thirteenth item L13 shows a cause of the failure judged from the failure contents. A fourteenth item L14 is the name of a component required for the repair (component to be replaced with).

A fifteenth item L15 is an estimated cost. The estimated cost includes a component price, a repair fee, and traveling expenses. A sixteenth item L16 is a visit date and time for a repair worker desired by the customer 2. A seventeenth item L17 is a specific remark for additional comments on repair contents, the customer 2, or the like. An eighteenth item L18 is a note that needs to be particularly checked in with the home-deliverer 4, the on-site repair station 5, and the like. A nineteenth item L19 is a time at which reception of the inquiry from the customer 2 ended.

A twentieth item L20 is the name of the station to which the operator who received the inquiry from the customer 2 belongs. A twenty-first item L21 is the name of the home-deliverer 4 who delivers the component. A twenty-second item L22 is the name of the office to which the operator who received the inquiry from the customer 2 belongs.

The above 22 items are stored as one set of inquiry data in the customer-inquiry reception database 10.

Next, various data stored in the reference database 11 will be described.

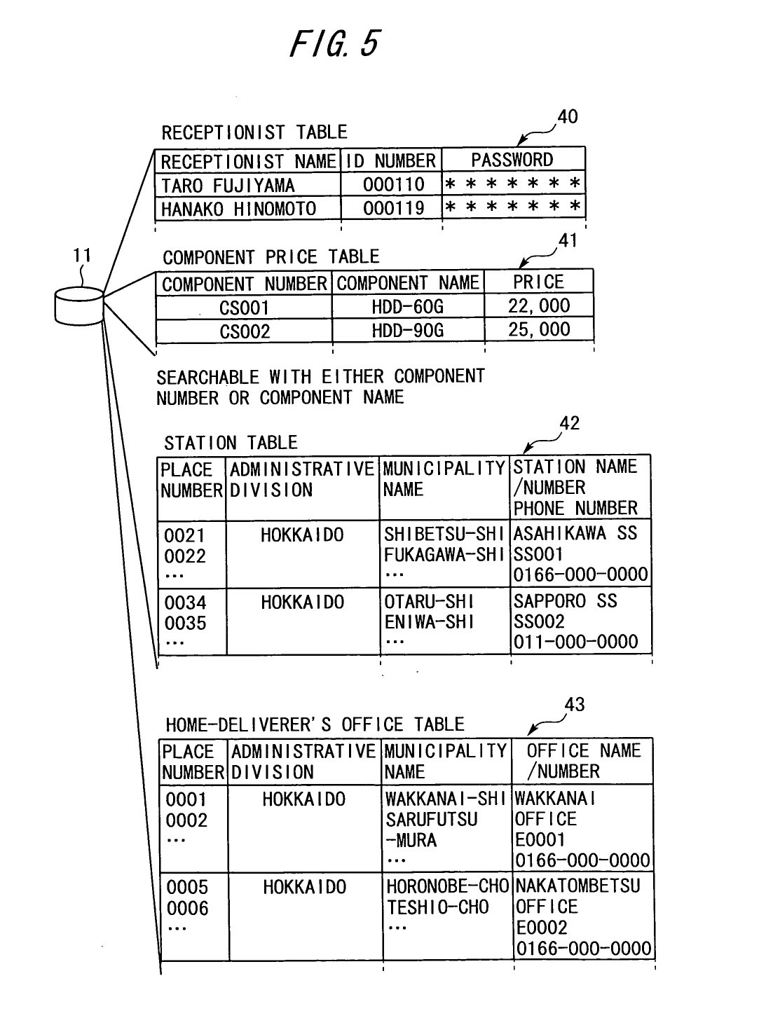

FIG. 5 shows a list of data stored in the reference database 11. The reference database 11 includes a receptionist table 40 for storing data concerning a receptionist who received the inquiry from the customer 2, a component price table 41 for storing data concerning the component required for the repair, a station table 42 for storing data concerning the on-site repair station 5 that dispatches a repair worker, and a home-deliverer's office table 43 for storing data concerning the home-deliverer 4 who home-delivers the component to the customer's residence 2.

The receptionist table 40 stores the name of the operator who received the inquiry from the customer 2 in association with an ID number and a password.

The component price table 41 stores a component number assigned to each component in association with the component name and component price.

The station table 42 stores a place number assigned to every station location in association with the administrative division, the municipality division, a station name, a station number, and a station phone number.

The home-deliverer's office table 43 stores an office name, an office ID (for example, A0001), and a phone number of each home-deliverer that performs home-delivery tasks in respective areas under the supervision of the home-deliverer 4, in association with an address and a place number of the deliverer's office.

Data stored in the reference database 11 is as described above. Next, the on-site service database 20 will be described.

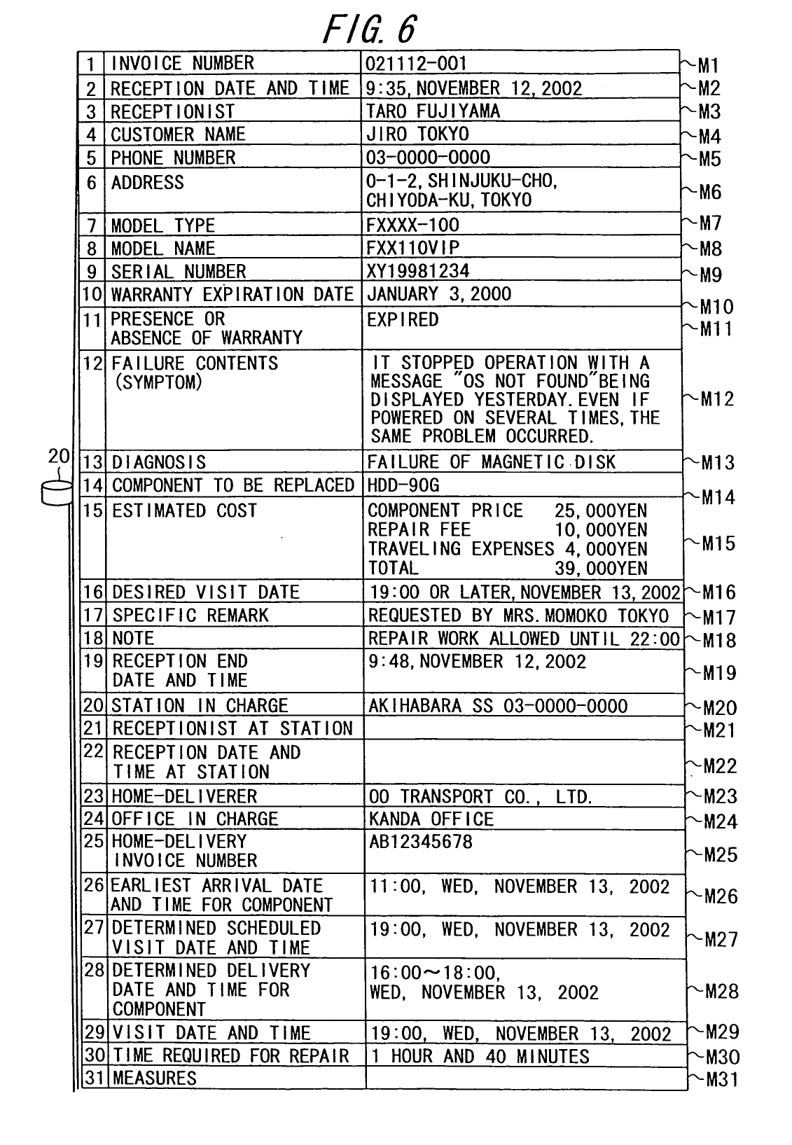

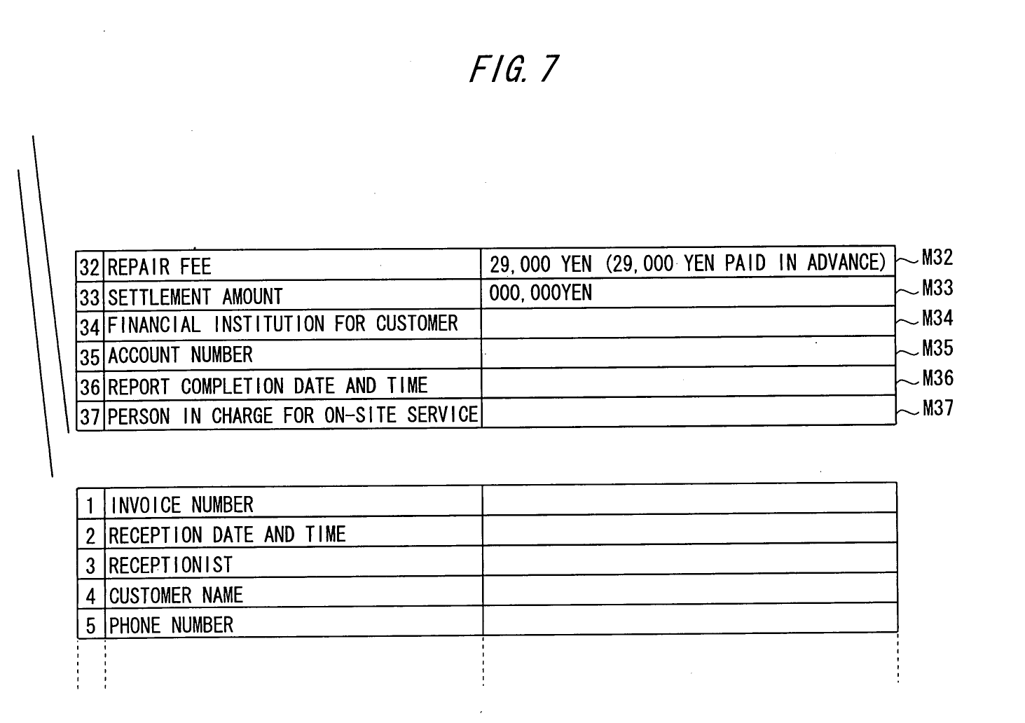

FIGS. 6 and 7 each show a list of various data stored in the on-site service database 20 of the embodiment. The on-site service database 20 stores data of 37 items for each inquiry made by a customer.

A first item M1 is an invoice number. It is preferable that the invoice number be automatically assigned to each inquiry from a customer 2 in the order of reception by the PC terminal 7 of the on-site repair reception center 3. A second item M2 is a date and time of reception of the inquiry from the customer 2. A third item M3 is the name of an operator who received the inquiry. A fourth item M4 is the name of the customer 2 who made the inquiry. A fifth item M5 is a phone number of the customer 2. A sixth item M6 is an address of the customer 2. A seventh item M7 is a model type of the device requiring repair. An eighth item M8 is a model name of the device requiring repair. A ninth item M9 is serial number of the device requiring repair. A tenth item M10 is warranty expiration (date) for the device requiring repair. An eleventh item M11 is presence or absence of a warranty for the device requiring repair.

Further, a twelfth item M12 is failure contents (symptom). The failure contents may be inputted in sentences or lists. A thirteenth item M13 shows a cause of the failure judged from the failure contents. A fourteenth item M14 is the name of a component necessary for the repair (component due to be replaced with).

A fifteenth item M15 is an estimated cost. The estimated cost includes a component price, a repair fee, and traveling expenses. A sixteenth item M16 is a visit date and time for a repair worker desired by the customer 2. A seventeenth item M17 is a specific remark for additional comments on repair contents, the customer 2, or the like. An eighteenth item M18 is a note that needs to be particularly checked in with the home-deliverer 4, the on-site repair station 5, and the like. A nineteenth item M19 is a time at which the reception of the inquiry from the customer 2 ended.

A twentieth item M20 is the name of the station to which the operator who received the inquiry form the customer 2 belongs. A twenty-first item M21 is the name of a receptionist who belongs to a station that instructs dispatch of a repair worker from the on-site repair reception center 3. A twenty-second item M22 is a date and time when the station receives the instruction for repair worker dispatch. A twenty-third item M21 is the name of the home-deliverer who is requested to deliver the component. A twenty-fourth item M22 is the name of the station to which the operator who received the inquiry from the customer 2 belongs.

A twenty-fifth item M25 is a home-delivery invoice number for the component. The invoice number is assigned by the home-deliverer 4 on delivering the component to the customer's residence. A twenty-sixth item M26 is an earliest scheduled arrival date and time for the component at the customer's residence. A twenty-seventh item M27 is a determined visit date and time. A twenty-eighth item M28 shows a time slot when the component reliably reaches at the customer's residence. A twenty-ninth item M29 is a visit date and time for the repair worker at the customer's residence.

A thirtieth item M30 is an approximate time required for the repair. A thirty-first item M31 is repair contents. A thirty-second item M32 is a repair fee required for the repair. A thirty-third item M33 is a settlement amount already paid. A thirty-fourth item M34 is a financial institution designated by the customer and a thirty-fifth item is an account number of an account with the financial institution 6 of the customer 2. A thirty-sixth item M36 is a report date and time of completion of maintenance tasks and a thirty-seventh item M37 is the name of the repair worker in charge for on-site service at the customer's residence.

Those 37 items are stored in the on-site service database 20. The various data stored in the embodiment is as described above.

<Screen Arrangement>

Next, description will be made on display screens for the terminals of the on-site repair reception center 3, the terminals of the home-deliverer 4, the Web-connected PC 19 at the on-site repair station 5, and the customer terminal 30.

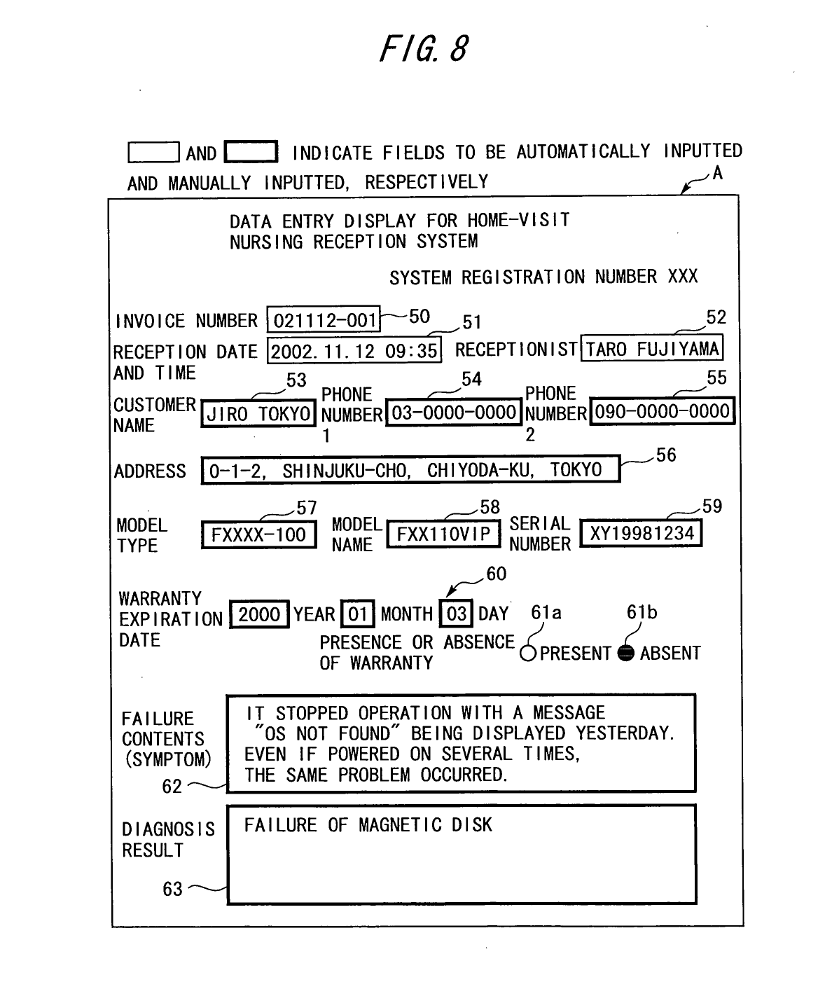

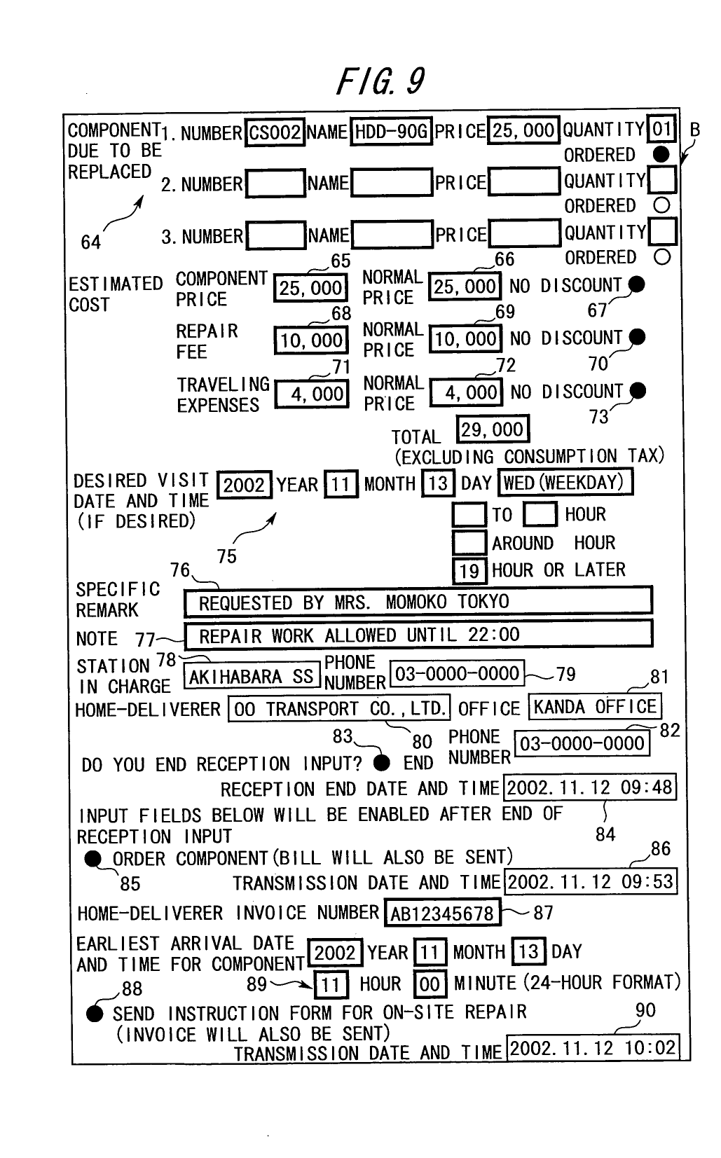

FIGS. 8 and 9 show screens A and B, respectively, to be inputted when the on-site repair reception center 3 receives an on-site service request.

The screen A displays a field 50 for inputting an invoice number, a field 51 for inputting a reception date and time of an inquiry for repair, and a field 52 for inputting the name of the operator who received the inquiry from the customer 2.

Further, the screen A displays a field 53 for inputting the name of the customer 2, fields 54 and 55 for inputting a phone number(s) of the customer 2, a field 56 for inputting the address of the customer 2, a field 57 for inputting a model type of the device requiring repair, a field 58 for inputting a model name of the device, a field 59 for inputting a serial number of the device, a field 60 for inputting a warranty expiration date, check boxes 61a and 61b for inputting presence or absence of a warranty, a field 62 for inputting failure contents (symptom), and a field 63 for inputting cause of the failure based on the failure contents.

Further, the screen B displays a field 64 for inputting a number, name, price, and quantity of the component necessary for the repair and whether or not the component is ordered, a field 65 for inputting the component price, a field 66 for inputting a normal price of the component, a field 68 for inputting a repair fee, a field 69 for inputting a normal fee of the repair fee, a field 71 for inputting traveling expenses, a field 72 for inputting a normal fee of the traveling expenses, a check boxes 67, 70, and 73 for indicating presence or absence of discounts for the respective fees, and a field 74 for displaying a total amount which is the addition of all the fees.

Further, the screen B displays a field 75 for inputting a visit date and time for the repair worker desired by the customer 2, a field 76 for inputting an additional comment and a specific remark for the case concerned, and a field 77 for inputting a note to be checked with various companies.

In addition, the screen B displays a field 78 for inputting the name of the on-site repair station that dispatches the repair worker for the case concerned, a field 79 for inputting a phone number of the on-site repair station 5, a field 80 for inputting the name of the home-deliverer in charge of delivery of the component, a field 81 for inputting the name of the office to which the home-deliverer belongs, and a field 82 for inputting a phone number of the office.

Further, the screen B displays a check box for indicating whether or not input of the on-site repair reception is complete and a field 84 for indicating a reception end date and time.

In addition, the screen B displays a check box 85, which will be enabled after termination of the reception, for indicating whether or not placement of order for the component is necessary, a field 86 for inputting an order placement date and time for the component, a field 87 for inputting an invoice number for a home-delivery package, a field 89 for inputting an earliest arrival date and time for the component, a check box 88 for inputting whether or not it is necessary to send an on-site repair instruction form, and a field 90 for displaying a submitting date and time of the on-site pair form to the on-site repair reception center 3.

Note that on the screens A and B shown in FIGS. 8 and 9, fields displayed with a thick line (fields 53 to 65, 68, 71, and 75 to 77) are manually inputted by an operator at the on-site repair reception center 3.

Further, it is preferable to adopt a structure in which the forms displayed on the screens A and B are attached to an e-mail and sent from the PC terminal 7 of the on-site repair reception center 3 to the customer 2. This allows the customer 2 himself/herself to fill in necessary information and send the filled-in forms back to the on-site repair reception center 3.

Next, description will be made of a screen for inputting necessary information when the on-site repair reception center 3 requests the home-deliverer 4 for home-delivery of the component.

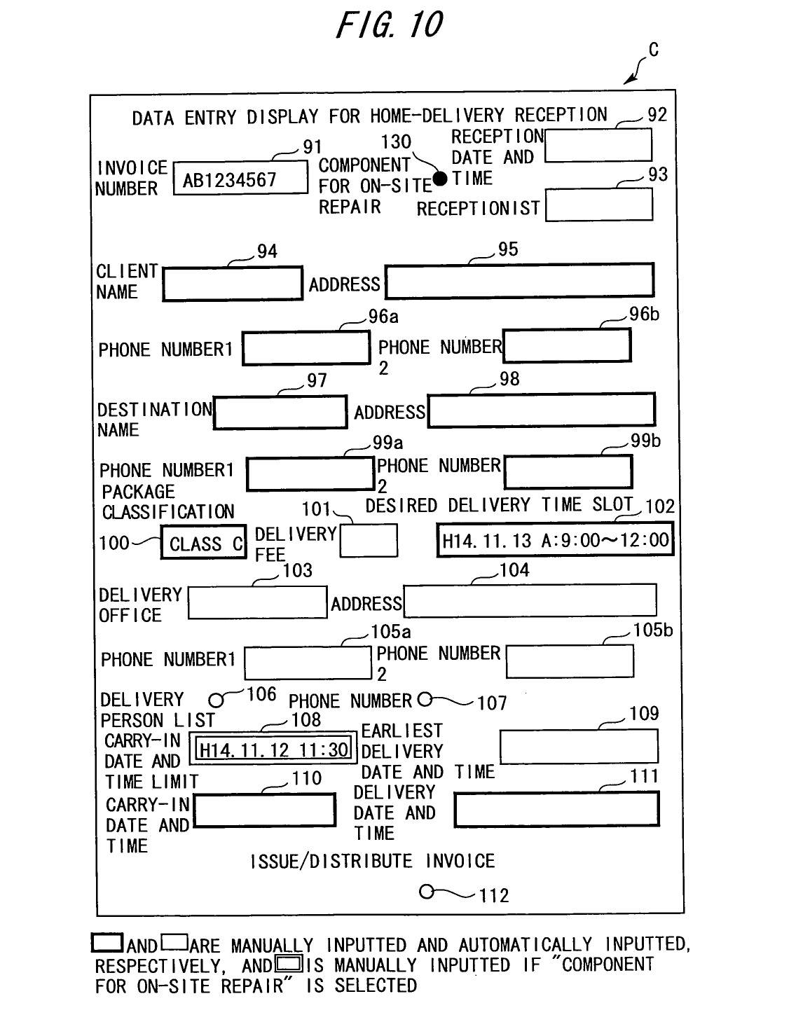

FIG. 10 is a screen C for inputting necessary information when the on-site repair reception center 3 requests the home-deliverer 4 for home-delivery of the component.

The screen C displays a field 91 for inputting an invoice number, a field 92 for inputting a reception date and time of home-delivery, a field 93 for inputting the name of the receptionist, a field 94 for inputting a client name who requested for delivery of the component, a field 98 for inputting an address of the client, and fields 99a and 99b for inputting a phone number of the client.

Further, the screen C displays a field 100 for inputting package classification of the component, a field 101 for inputting a delivery fee, a field 102 for inputting a desired delivery time slot, a field 103 for inputting the name of the delivery office that performs delivery, a field 104 for inputting an address of the office, fields 105a and 105b for inputting phone numbers of the office, a check box 106 for inputting whether or not a list of delivery persons is necessary, a check box 107 for inputting whether or not a mobile phone number of the delivery person is necessary, a field 108 for inputting a carry-in limit for the component, a field 109 for inputting an earliest delivery date and time for the component, a field 110 for inputting carry-in date and time for the component, a field 111 for inputting a delivery date and time for the component, and a check box 112 for inputting whether or not issue/distribution of an invoice is necessary.

In addition, the screen C displays a check box 130 for inputting whether or not the component to be delivered is the component required for on-site repair. When the check box is checked, a flag is set on a memory (not shown) of the PC terminal 7. By the way, the field 108 for inputting the carry-in limit for the component will be enabled by checking the check box.

Note that it is preferable that the fields displayed with thick lines (94 to 100, 102, 110, 111) on the screen C in FIG. 10 be inputted by the client who requested for delivery (an operator at the on-site repair reception center 3 or an operator at the component warehouse 9 in the embodiment).

Next, description will be made of screens for an on-site repair instruction/report form to be sent from the on-site repair reception center 3 to the on-site repair station 5.

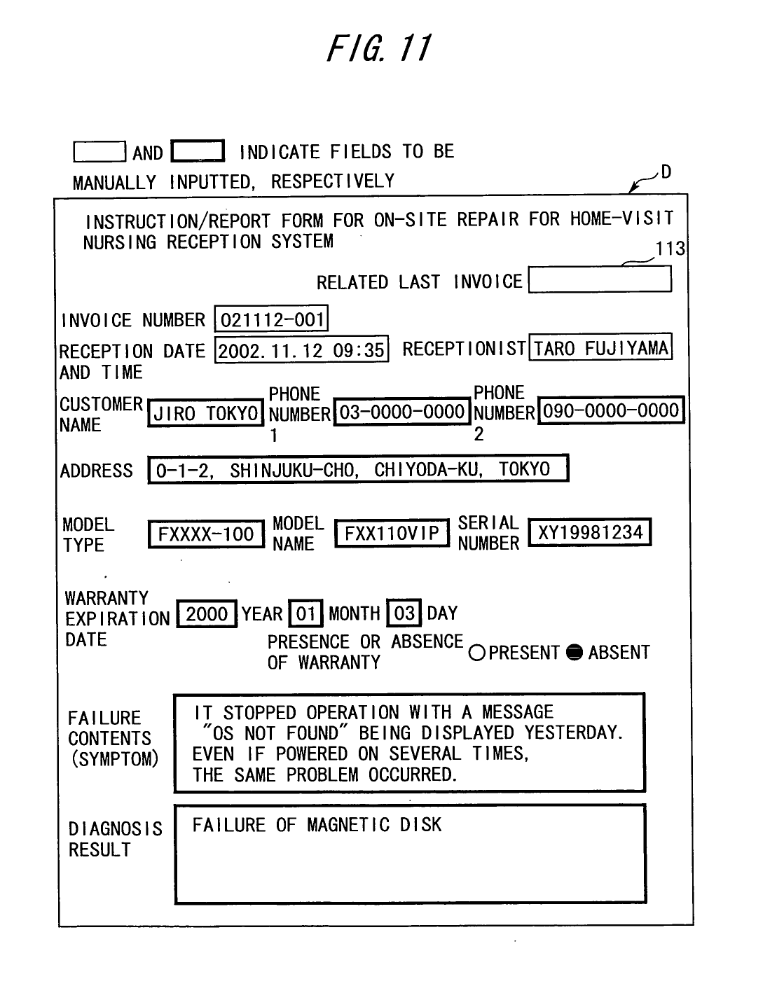

FIGS. 11 to 13 show screens D, E, and F, respectively, for the on-site repair instruction/report form. Display contents of the screen D are almost the same as those of the screen A in FIG. 8 and thus, description of those that duplicate will be omitted. The difference between the screen A and the screen D is that the screen D displays a field 113 for inputting, in the case where there exists a previous invoice that is a related invoice, an invoice number of the related invoice.

Further, display contents of the screen E is almost the same as those of the screen B and in FIG. 9 and thus, description of those that duplicate will be omitted. The difference between the screen B and the screen E is that the screen E does not display the fields 83 to 88 and field 90, which are displayed on the screen B. Instead, the screen E displays a field 114 for inputting a reception date and time of the instruction form at the on-site repair station 5, a field 115 for inputting a determined scheduled visit date and time for the repair worker at the customer's residence, and a field 116 for inputting a determined scheduled delivery date and time for the component.

Further, the screen F is inputted after the repair worker visits the customer's residence and completes the repair. The screen F displays a field 117 for inputting a visit date and time at the customer's residence, a field 118 for inputting a time required for the repair, a field 119 for inputting measures taken for the repair, fields 120 for inputting the repair fee, a field 121 for inputting the name of the repair worker, a check box 122 for inputting whether or not the customer 2 has settled the repair fee after completion of the repair, a check box 123 for inputting a settlement amount after the check box 122 is checked, a field 124 for inputting a financial institution name, a field 125 for inputting an account number, and a check box for inputting whether or not a report is to be prepared. Note that it is desirable that the fields (115 to 121) displayed with thick lines on the screens D, E, and F be manually inputted by an operator at the on-site repair station 5. The input fields of the screen F may be inputted by the repair worker using the mobile terminal 21a.

Described above is the explanation of the display screens for the terminals at the on-site repair reception center 3, the terminals at the home-deliverer 4, the Web-connected PC 19 at the on-site repair station 5, the customer terminal 30, and the mobile terminal 21a of the repair worker assisting system 1 according to the embodiment.

<Repair Worker Assisting System Flow>

Next, description will be made of a flow of the repair worker assisting system 1 according to the embodiment by way of a flowchart.

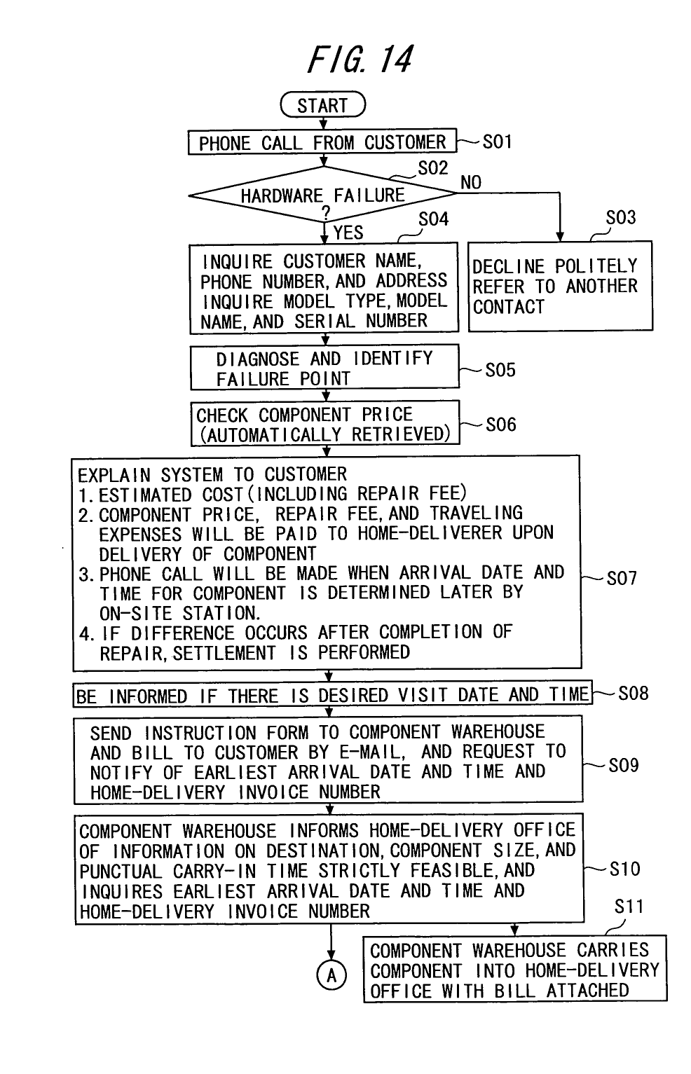

FIGS. 14 to 16 show a system flow of the repair worker assisting system 1 according to the embodiment. Note that in description given below, the case is explained where the customer 2 directly inquires of an operator at the on-site repair reception center 3 through a phone call.

The operator in the on-site repair reception center 3 receives the phone call from the customer 2 on a device failure (S01). The operator inquires of the customer 2 about failure contents of the device and judges whether or not a hardware part of the device is broken down (S02). At this time, if it is confirmed that the hardware part is not broken down, the operator provides a guidance of an appropriate maintenance information desk (S03).

On the other hand, in step 02, if it is confirmed by the operator that the hardware part is broken down, the operator inquires about a name, phone number, and address of the customer 2, a model type, model name, and serial number of the device to be repaired, and the like (S04). At this time, the operator displays the screen A shown in FIG. 8 (hereinafter, referred to as “on-site repair reception form”) in a display of the personal computer terminal 7 and inputs items given by the customer 2 in order.

After that, when completing the inquiry of the customer 2 about all items relating to the failure, the operator specifies a failure point based on the diagnosis (S05). When the failure point is specified, the operator inputs the cause of failure in a field 63 for inputting the diagnosis by the on-site repair reception center.

Further, the operator judges whether or not any component is required based on the cause of failure and if it is judged that the repair needs some component, the operator selects an appropriate component and checks the component price (S06). The component price is retrieved from the component price database 41 shown in FIG. 5. At this time, the operator inputs various data relating to the required component in appropriate fields in the screen B shown in FIG. 9 (hereinafter, referred to as “on-site repair reception form”).

Next, the operator explains to the customer 2 an outline of the repair worker assisting system 1 (S07). The explanation contents on the outline includes (1) an estimated cost required for repair, (2) that a repair fee should be paid to the home-deliverer 4 upon delivery, (3) that a contact is made from the on-site repair station 5 on that location when a component arrival date and time is determined, and (4) that settlement is performed at another time if there should be a difference after completion of repair.

Subsequently, the operator inquires of the customer 2 about a desired visit date and time (S08). The operator confirms the desired visit date and time with the customer 2, and then inputs the date in the field 75 shown in FIG. 9 in which the desired visit date is entered.

In addition, the operator inquires of the customer 2 about an additional comment relating to the repair or delivery, an item to be informed to the home-deliverer 4 or the on-site repair station 5, or the like. The operator inputs the specific remark and note obtained at this time in the field 76 for inputting the specific remark and in the field 77 for inputting the note, in the on-site repair reception form, respectively.

Thus, the repair inquiry of the customer 2 ends and the reception is completed. Then, based on the address of the customer 2, the personal computer terminal 7 of the on-site repair reception center 3 retrieves an on-site repair station 5 that is nearest to the address of the customer 2 and the phone number of the on-site repair station 5 from the station table 42 in the reference database 11 shown in FIG. 5.

In addition, based on the address of the customer 2, the personal computer terminal 7 retrieves for a home-deliverer 4 that is nearest to the address of the customer 2 and the phone number of the home-deliverer 4 from the home-deliverer's office table 43 in the reference database 11.

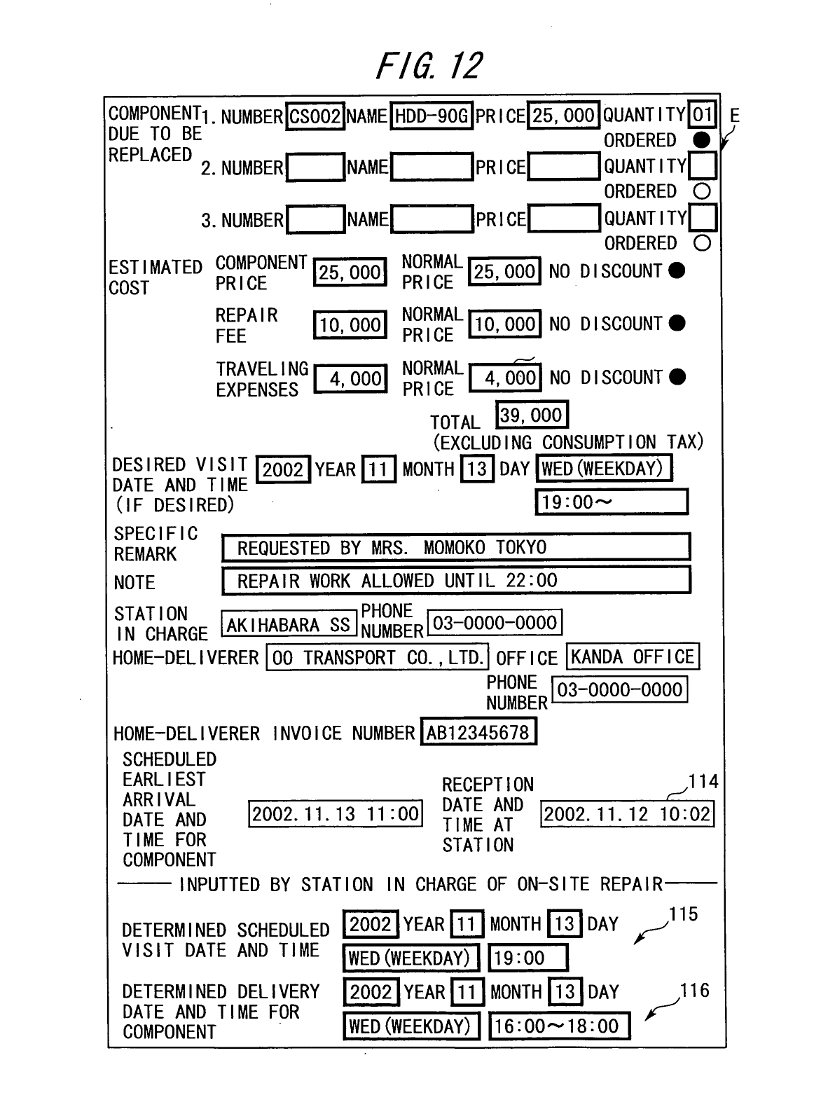

After that, the operator inputs the retrieved on-site repair station 5 and home-deliverer 4 in the field 78 for inputting the station in charge (its phone number to be inputted in the field 79) and in the fields 80 and 81 for inputting the home-deliverer 4 in charge (its phone number to be inputted in the field 82), in the on-site repair reception form, respectively. In this way, the on-site repair reception form having necessary items inputted serves as the on-site repair instruction form shown in FIGS. 11 and 12.

The operator then sends a bill (an estimate) for the repair fee to the customer terminal 30 by way of an e-mail and at the same time, sends the on-site repair instruction to a terminal of the component warehouse 9 (S09). That is, the on-site repair reception center 3 orders the component to the component warehouse. At this time, it is described in the e-mail that a contact should be made to the on-site repair reception center 3 immediately after the earliest arrival date and time for the component and the home-delivery invoice number are found out.

At this time, an operator at the component warehouse requests the designated home-deliverer's reception branch 15 to deliver the component based on the description in the on-site repair instruction form. The operator at the component warehouse informs the home-deliverer's reception branch 15 of the address of the delivery destination (customer 2), the size of the component, and the punctual carry-in time strictly feasible for the component.

In addition, the operator at the component warehouse informs the home-deliverer 4 of the request that a contact should be made when the earliest component arrival date and time and the home-delivery invoice number are found out, which have been requested by the on-site repair reception center 3 (S10).

Then, an operator at the home-deliverer's reception branch 15 inputs the address of the delivery destination and the time limit for carrying-in of the component, which have been notified by the operator at the component warehouse, in a delivery reception input screen C shown in FIG. 10 to be displayed in a terminal of the home-deliverer's reception branch 15. In addition, the operator in the home-deliverer's reception branch 15 inputs a package classification that is found out according to the component size in the field 100 for inputting the package classification, in the delivery reception input screen C.

Here, the operator at the home-deliverer's reception branch 15 checks the check box 130 indicating whether or not the package is the on-site repair component displayed in the delivery reception input screen C shown in FIG. 10 (hereinafter, referred to as “home-deliverer's reception invoice”). By checking the checkbox, a flag is set, which indicates that the package to be home-delivered is a component for the on-site repair.

Following this, the earliest component arrival date and time and the home-delivery invoice number are calculated to be outputted at the reception branch terminal 15a. The earliest component arrival date and time is calculated from the distance to the address of the customer 2 and other home-delivery schedules. The home-delivery invoice number is assigned in the order of home-delivery reception.

The operator at the home-deliverer's reception branch 15 sends an e-mail mentioning the calculated earliest component arrival date and time and home-delivery invoice number of the component to the terminal 9a of the component warehouse 9.

Upon receiving the e-mail, the operator at the component warehouse carries the component attached with a bill into the home-deliverer's reception branch 15 (S11).

In the home-deliverer's reception branch 15, it is confirmed that the component is attached with the bill, and the component and the bill are sent to the home-deliverer's delivery branch 16 designated by the on-site repair reception center 3.

Meanwhile, the operator at the component warehouse 9 sends from the terminal 9a an e-mail mentioning the earliest component arrival date and time and home-delivery invoice number of the component notified by the home-deliverer's reception branch 15 to the on-site repair reception center 3.

When receiving the e-mail from the terminal 9a of the component warehouse 9 (S12), the operator at the on-site repair reception center 3 inputs the home-delivery invoice number and the earliest component arrival date and time in the field 87 for inputting the home-delivery invoice number and the field 89 for inputting the earliest component arrival date and time, of the on-site repair instruction form and the home-deliverer's reception invoice shown in FIGS. 10 and 11, respectively.

After that, the operator sends an e-mail attached with the on-site repair instruction form and the home-deliverer's reception invoice to the terminal of the designated on-site repair station 5 (S13).

When the terminal of the on-site repair station 5 receives the e-mail, the operator at the on-site repair station 5 refers to the attached on-site repair instruction form or the home-deliverer's reception invoice and make a phone call to the customer 2 to determine a visit date and time (S14). The visit date and time is determined in such a manner that one hour after the earliest component arrival date and time is used as a reference.

When the visit date and time is determined, the operator at the on-site repair station 5 notifies the home-deliverer's delivery branch 16 of the desired delivery date and time of the customer 2 (S15). As a result, a desired delivery time slot is determined. Here, it is preferable that the home-deliverer's reception branch 15 be informed of the delivery time slot as a precautionary measure.

Then, in the on-site repair station 5, a schedule of on-site service is prepared for the repair worker (S16).

Meanwhile, the home-deliverer's delivery branch 16 notified of the desired delivery date and time confirms that the component and the bill have arrived from the component warehouse 9 and instructs the delivery person 18 to home-deliver the component and the bill (S17). Upon arrival at the customer's residence 2, the delivery person 18 hands the bill to the customer 2 to charge the repair fee in cash. After the repair fee payment, the delivery person 18 receives a signature from the customer for certification of the receipt.

At this time, if the customer 2 does not pay the charged repair fee, the delivery person 18 informs the customer 2 that cancellation for the on-site repair of this time is applied and charges the cancellation fee (S19). Here, in either case where the customer 2 pays the cancellation fee or not (S20), the delivery person 18 notifies the on-site repair station 5 or the repair worker that the on-site repair is to be cancelled through the mobile terminal 18a (S21), and brings back the component to return it to the component warehouse. Note that in the case where the delivery person 18 notifies the on-site repair station 5 that the on-site repair is to be cancelled, the on-site repair station 5 notifies the repair worker 21 of that effect. Alternatively, when the delivery person 18 directly contacts the repair worker 21, their mobile terminals 18a and 21a are used for the contact.

After that, the repair worker 21 receiving the notification of the on-site repair cancellation is prepared to visit the next customer (S22).

Incidentally, the cancellation fee is paid into an account of the on-site repair reception center 3 (repairer) via an accounting department (common to the home-deliverer's reception branch) of the home-deliverer's delivery branch 16 in the same manner as the repair fee (S23). Note that the customer 2 may pay the cancellation fee and the repair fee directly into the account of the on-site repair reception center 3.

In step 18, when the customer 2 pays the full amount of the charge (repair fee), the delivery person 18 hands the component to the customer 2 (S24). After that, the delivery person 18 uses the mobile terminal 18a in hand to notify the on-site repair station 5 or the repair worker 21 that the component is handed to the customer 2 (S25).

The repair fee received by the customer 2 is paid into the account of the on-site repair reception center 3 via the accounting department of the home-deliverer's delivery branch 16 in the same manner as the cancellation fee (S23).

After being notified that the component was delivered to the customer's residence 2 and the customer 2 paid the repair fee, the repair worker 21 visits the customer's residence 2 for the repair (S26).

When the repair is completed, the repair worker 21 checks whether or not the actual repair fee (including the repair time) for the repair is higher than the estimated cost described on the on-site repair instruction form (S28). At this time, if the actual repair fee is higher than the estimated cost, the customer 2 pays the deficient amount into an account designated by the on-site repair reception center 3 (S29). Alternatively, the customer 2 may pay the deficient amount of the repair fee to the repair worker in cash on the spot.

On the other hand, in step 28, in the case where the repair worker 21 confirms that the actual repair fee for the repair is not higher than the estimated cost, the repair worker 21 checks whether or not the actual repair fee for the repair is lower than the estimated cost (S30). At this time, if the actual repair is lower than the estimated cost, the on-site repair reception center 3 pays the excess collected amount of the repair fee into an account of the customer 2 (S31). Also, the repair worker 21 may pay the excess collected amount to the customer 2 in cash on the spot.

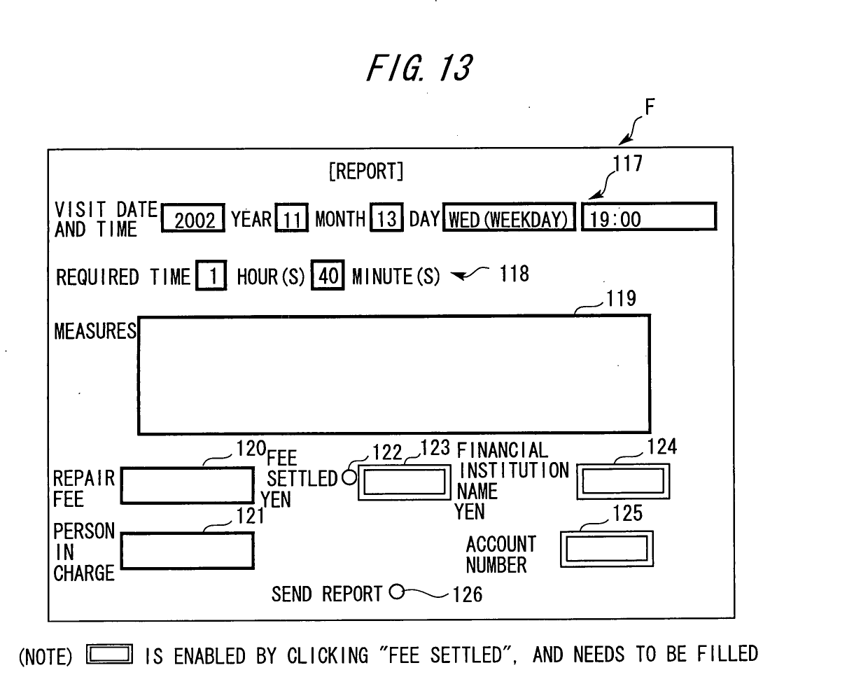

On the other hand, in step 30, when the repair worker 21 confirms that the actual repair fee for the repair is not lower than the estimated cost, the on-site repair ends. (S32). The repair worker 21 visits the next customer or goes back to the branch to prepare a report by inputting appropriate items in the screen F shown in FIG. 13. When completing the input for the report, the repair worker 21 attaches this report to an e-mail to send it to the on-site repair reception center 3.

The above description is for the process sequence for the maintenance tasks using the repair worker assisting system 1 according to the embodiment.

<On-Site Repair Automatic Schedule>

In step 16 during the process of the maintenance tasks described above, a schedule of on-site service for the repair worker 21 in the on-site repair station 5 is automatically prepared.

In this connection, next, the on-site repair automatic schedule for the repair worker at the on-site repair station 5 will be described.

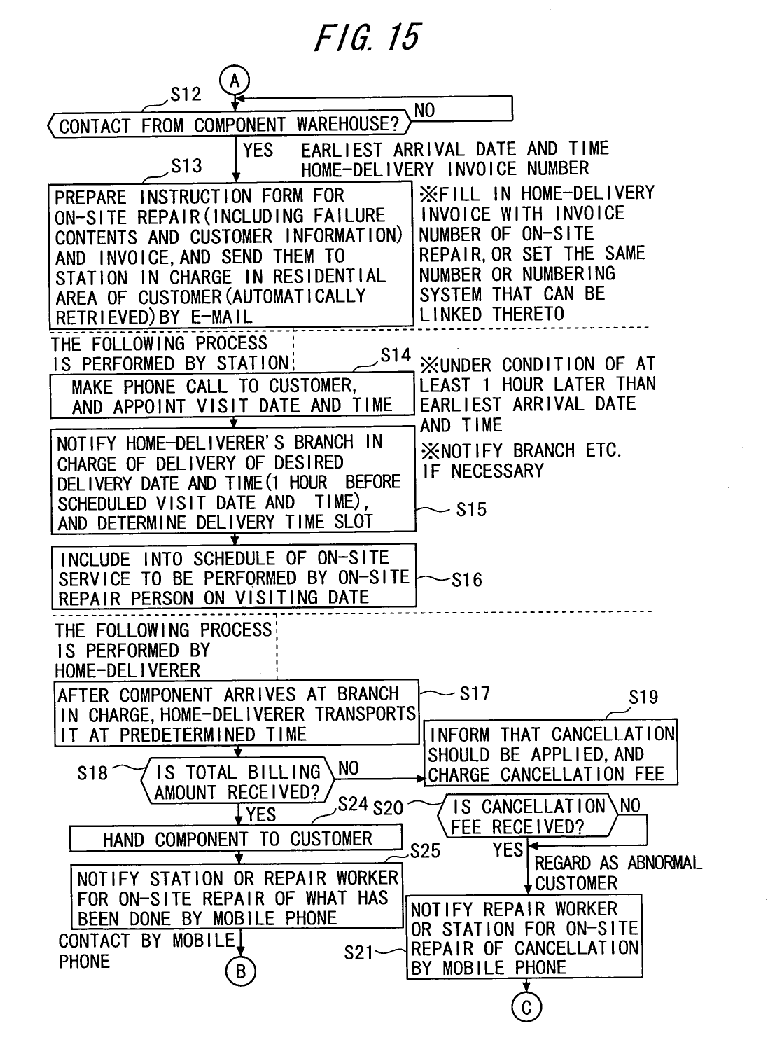

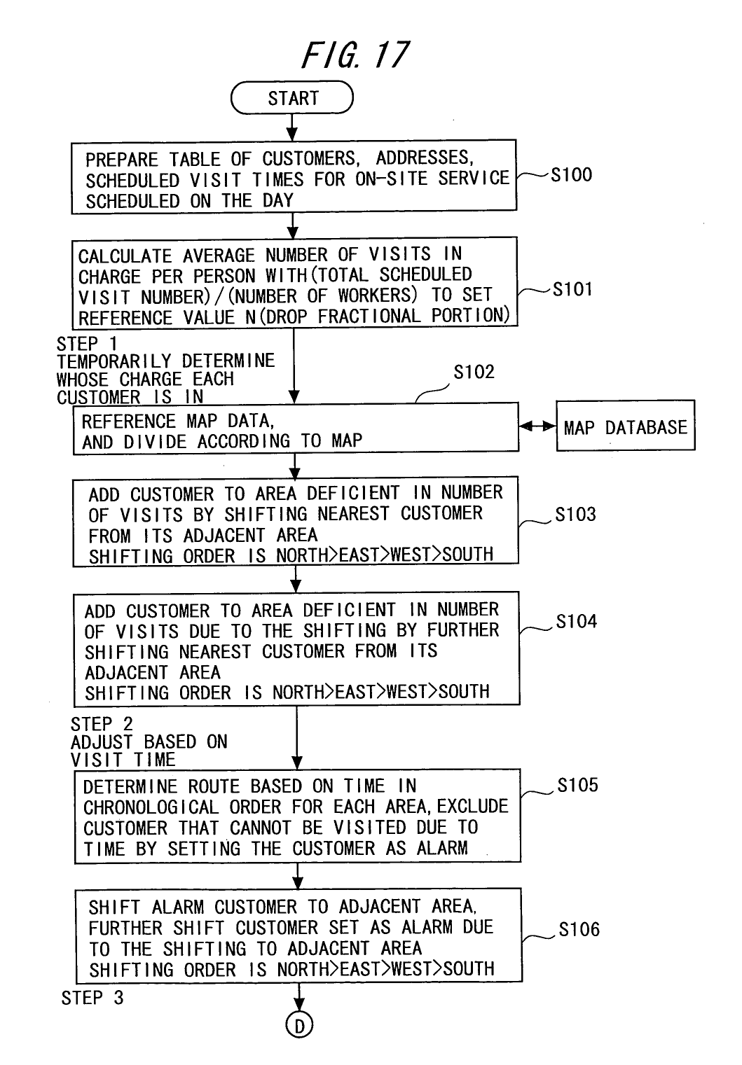

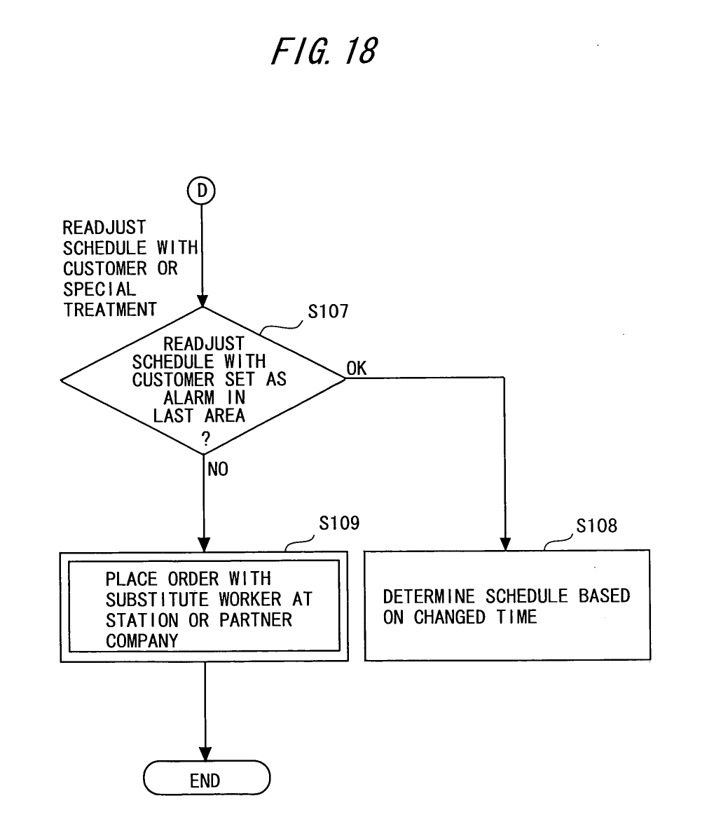

FIGS. 17 and 18 show a sequence of automatically preparing the on-site repair schedule in the on-site repair station 5. Note that preparation of the on-site repair automatic schedule is executed by the Web-connected personal computer 19 at the on-site repair station 5. For example, this process is executed in step 16 in FIG. 15. More specifically, the preparation is realized by executing a program stored in a hard disk in the Web-connected personal computer 19 and dedicated to prepare the on-site repair schedule using a CPU (not shown).

At the on-site repair station 5, when the desired visit date and time is determined by the customer 2 to be visited, in order to prepare an on-site repair schedule for the on-site repair schedule, a table of customers 2, addresses, scheduled visit times for the on-site services is prepared in the Web-connected personal computer 19 based on the on-site repair instruction form (S100).

In the Web-connected personal computer 19, the average number of visits in charge per person is calculated by dividing the total scheduled visit number by the number of repair workers from this table (S101). The calculated average number of visits in charge per person is set as a reference value.

In addition, in the Web-connected personal computer 19, a visit district is divided into areas with reference to map data stored in the hard disk. (S102).

After that, the average number of visits in charge per person is calculated for each divided visit area (hereinafter, referred to as “visit area”). Here, areas having the number of visits lower than the reference value of the average number of visits in charge per person are picked up.

A customer is added to an area having the least average number of visits in charge per person by shifting a nearest customer 2 from its adjacent area (S103). Note that as the shifting order, there is an order for shifting sequentially a customer 2 in an area in north→an area in east→an area in west→an area in south, for example.

Then, a customer is added to the area having the customer 2 shifted to the adjacent area by further shifting a nearest customer from its adjacent area (S104).

Next, a visit route is determined based on the desired visit date and time and the address of the customers 2 indicated on the on-site repair instruction form in the Web-connected personal computer 19 at the on-site repair station 5 (S105). Note that conditions for preparing the visit route are as follows: (1) its movement is performed at 25 km/H by driving a car on general roads and (2) its working hour is set to 2 hours/task in average.

Here, an alarm in sound or alarm on the display of the Web-connected personal computer 19 is set to a customer 2 for whom the visit cannot be made at the desired time. The alarm is not released until all visit route preparation is completed.

When all visit route preparation is completed, the Web-connected personal computer 19 shifts the customer 2 with the alarm to an adjacent area (S106). Note that with this shift, the customer 2 with the alarm is further shifted to its adjacent area.

While the customer 2 with the alarm is kept shifted in this way, there is a possibility that the customer 2 shifted to the final area has an alarm set. In such a case, the operator at the on-site repair station 5 contacts the customer 2 to readjust the visit date and time (S107). Through this process, change of the visit date and time is determined by the customer 2, thus determining all schedule of on-site service (S108).

On the other hand, if the readjustment of the visit date and time is not achieved with the customer 2, a cooperation is called for a substitute repair worker at the on-site repair station 5 in each area or for a partner company (S109).

The above description is for the step of automatically preparing the on-site repair schedule according to the embodiment.

<Automatic Schedule Preparation for Interrupting Additional Customer 2>

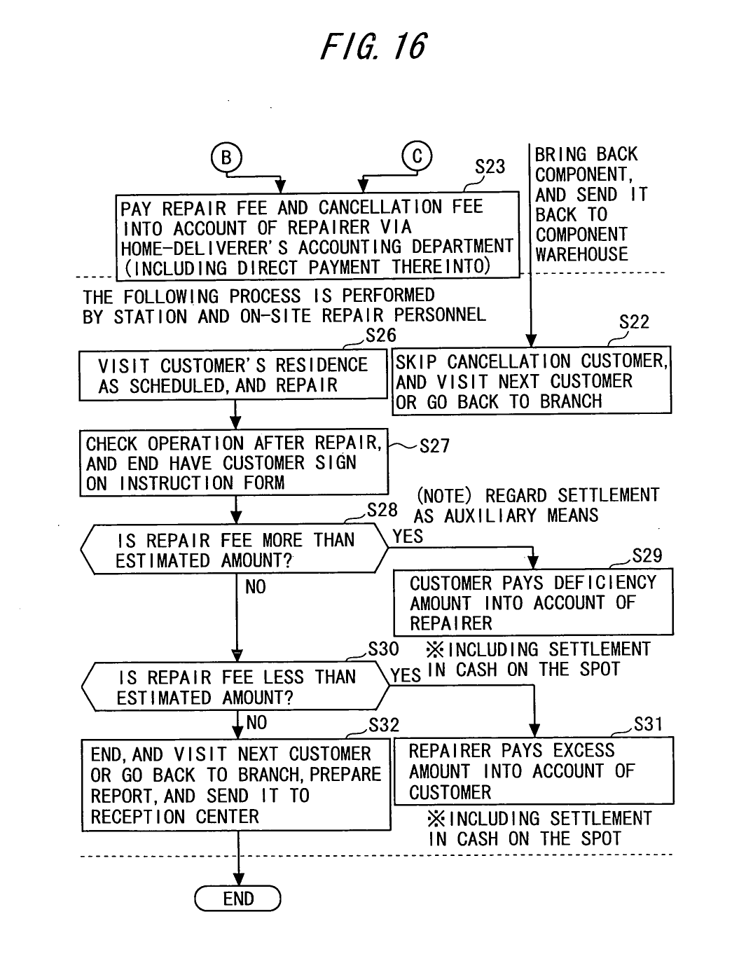

Subsequently, description is made of a process performed in the Web-connected personal computer 19 at the on-site repair station 5 when the on-site repair at suddenly cancelled or an emergency customer 2 interrupts to request an on-site repair as in the case of step 22 in FIG. 16.

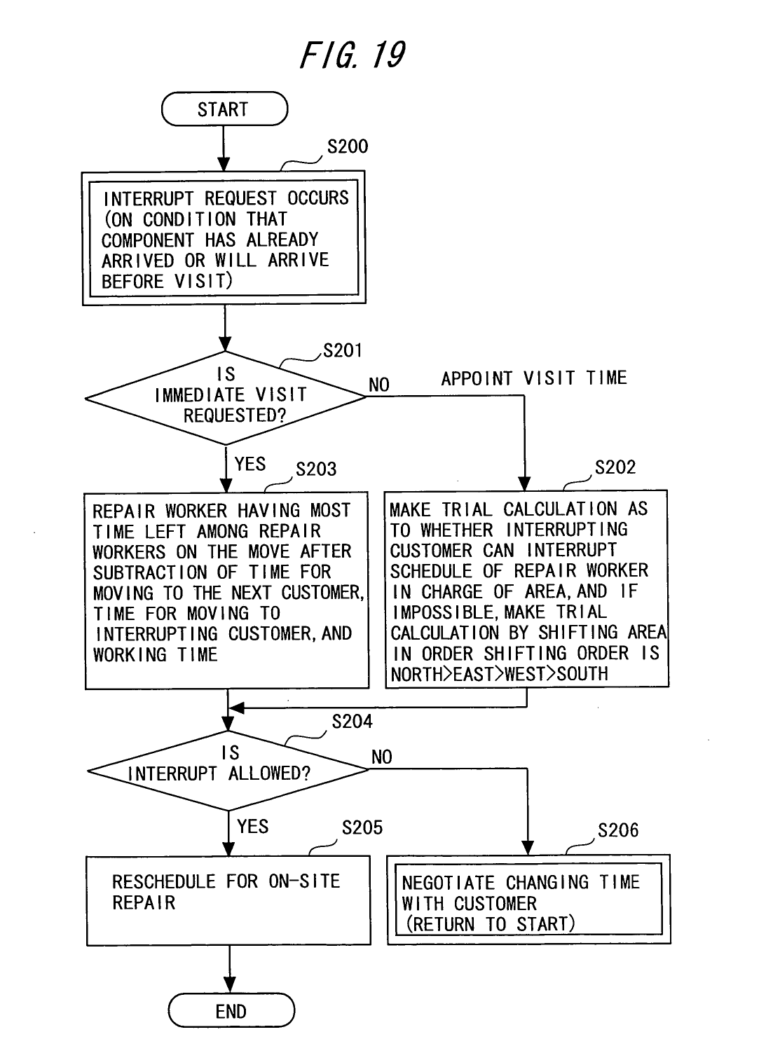

FIG. 19 shows a flow chart of an automatic schedule preparation for the interrupting additional customer 2. Note that the process is performed on condition that the component has already arrived at the customer's residence or the component is expected to be arrived at the customer's residence before a repair worker arrives.

First, an irregular customer 302 makes an interrupting request for an on-site repair to the on-site repair station 5 or the on-site repair reception center 3 (S200). Following this, the on-site repair station 5 or the on-site repair reception center 3 checks with the customer 302 whether or not the interrupting request urges an immediate visit (S201).

Here, in the case where the customer 302 designates a visit date and time without an immediate visit request, a trial calculation is performed as to whether or not the interruption is allowed in the schedule of the area corresponding to the customer 302 depending on the above-mentioned conditions ((1) its movement is performed at 25 km/H by driving a car on general roads and (2) its working hour is set to 2 hours/task in average) (S202).

According to the trial calculation, if it is judged that the interruption cannot be made in the schedule of the corresponding area, an area where the interruption cannot be made is retrieved by shifting the areas in order from the area nearest to the above area.

On the other hand, it is confirmed that the customer 302 requests an immediate visit in step 201, an appropriate repair worker is selected from among repair workers on the move for on-site repairs (S203). The selection of the appropriate repair worker is performed based on schedules for the repair workers stored in the database 20 in the Web-connected personal computer 19 in the on-site repair station 5. For example, repair workers on the move for on-site repairs are extracted from the on-site service database 20. Further, time for moving to the next customer and time for moving to an irregular customer's residence (not shown) are calculated from information stored in the on-site service database 20. In addition, a repair working time is calculated based on the repair contents. While considerations are given to those kinds of time and the number of repair workers, a repair worker having much time left is selected to visit the irregular customer's residence.

Then, the Web-connected personal computer 19 sends an e-mail inquiring as to whether or not the interruption is allowed in the schedule of on-site service to the mobile terminal 21a of the extracted repair worker 21 (S204).

In the case where the interruption is allowed in the schedule, the extracted repair worker sends an e-mail notifying that the interruption is allowed in the schedule to the Web-connected personal computer 19 in the on-site repair station 5.

Upon reception of the e-mail by the Web-connected personal computer 19 at the on-site repair station 5, the Web-connected personal computer 19 reschedules for the on-site repair (S205).

On the other hand, in step 204, if the interruption is not allowed in the schedule, the repair worker 21 sends an e-mail notifying of that effect to the Web terminal 19 at the on-site repair station 5. After that, the operator at the on-site repair station 5 negotiates changing the time with the customer 302 through a phone call (S206).

Described above is the explanation of the automatic schedule preparation for an interrupting additional customer according to the embodiment.

As described above, according to the repair worker assisting system 1 and method of the embodiment, it is possible to have a customer to pay the repair fee in exchange for a component. Accordingly, the repair fees can be collected at a high rate.

Further, according to the repair worker assisting system 1 and method of the embodiment, even if the on-site repair is suddenly canceled, it is possible to efficiently schedule a visit to the next customer. Accordingly, the maintenance tasks can be performed smoothly.

Further, according to the repair worker assisting system and method of the embodiment, the average number of visits in charge is calculated for each area, and the customers are assigned in order from the area with a small number of the visits in charge. Accordingly, the imbalance among the numbers of the tasks per area can also be suppressed to be as low as possible.

Note that according to the description of the embodiment, the repair worker assisting system 1 is executed through an operator, but all the operation of the operator may be performed with terminals.

For example, as to the on-site repair reception from a customer, the customer inputs required information in the data entry display for on-site repair reception shown in FIGS. 8 and 9, and sends it to the on-site repair reception center 3.

Also, the adjustment of the desired home-delivery date and time or the on-site repair date and time may be performed through the transmission of e-mails.

Further, when the desired home-delivery date and time and the on-site repair date and time are determined, an e-mail that instructs to delivery a component or to perform on-site repair may be automatically sent to a delivery person or a repair worker.

Further, according to the description of the embodiment, the customer is regarded as an individual user who owns (uses) equipment, but there is no limitation thereto. For example, the customer may be a company and a store who deal in the equipment. In addition, the terminal of the customer is not limited to the terminal owned by the customer himself/herself. The customer can utilize the system according to the embodiment with an arbitrary terminal.

As has been described above, according to the present invention, there can be provided a repair worker assisting method, a repair worker assisting program, a repair worker assisting system, and a terminal, which are capable of improving the collection rate for repair fees from customers.

Further, according to the present invention, there can be provided a repair worker assisting program, a repair worker assisting system, and a terminal, which are capable of performing on-site repair tasks with high efficiency and flexibility.

What is claimed is:

1. A repair worker assisting method for assisting a repair worker who visits a customer's residence to perform maintenance of equipment, the method comprising:
instructing to deliver a component for replacement upon receiving a request from the customer; and
notifying the repair worker that a repair work is ready to start upon having accepted the customer's payment for the component.

2. A repair worker assisting method, comprising:
receiving repair content data inputted from an apparatus of a customer;
calculating a repair fee based on the repair content data;
judging whether or claim a repair component is necessary based on the repair content data;
upon judging that the repair component is necessary in the preceding step, notifying an apparatus on a side of a deliverer who delivers the repair component of an instruction for delivering the repair component to the customer;
after delivering the repair component to the customer, receiving a notification of completion of delivery from the deliverer;
upon receiving the notification, notifying the apparatus of the customer of billing of the repair fee;
after the customer has paid the repair fee into a predetermined financial institute, receiving a notification of completion of payment from an apparatus on a side of the financial institute; and
upon receiving the notification of completion of payment, instructing to dispatch a repair worker to the customer's residence.

3. A repair worker assisting method according to claim 1, comprising:
receiving an input of address data of the customer's residence;
referencing map data containing a position of a station located for each area; and
extracting an appropriate station based on the address data.

4. A repair worker assisting method according to claim 1, comprising:
receiving an instruction for dispatching a repair worker from a server that assists dispatch of a repair worker who performs a maintenance task;
when the instruction for dispatching the repair worker is issued from the server, referencing a database that serves to manage a current location of the repair worker;
extracting an appropriate repair worker based on address data of a customer's residence to be visited; and
notifying a mobile apparatus owned by the repair worker of a dispatch instruction.

5. A repair worker assisting method according to claim 4, comprising:
receiving an instruction for dispatching a repair worker from the server;
referencing a database that serves to manage a scheduled visit number for each repair worker and the assigned number of repair workers for each area; and
calculating an average number of visits in charge per repair worker from the scheduled visit number for repair workers and the assigned number of workers for each area to issue a dispatch instruction in order from the repair workers in an area with a small average number of visits in charge per repair worker.

6. A repair worker assisting method according to claim 1, including a step of, based on a location of the repair worker, a location of the customer's residence to be visited, and predetermined conditions, retrieving a route to the customer's residence in a chronological order for the visit time.

7. A repair worker assisting method according to claim 6, including a step of, in the case where it is impossible to be in time for the visit time with a calculated route in the preceding step, issuing from an apparatus of the repair worker an instruction for requesting an adjacent station to issue a dispatch instruction.

8. A repair worker assisting method according to claim 1, comprising:
receiving a sudden request for on-site repair from a customer;
referencing a database storing a schedule assigned to each repair worker; and
extracting a repair worker having much time left in his/her schedule based on data stored in the database.

9. A repair worker assisting method according to claim 8, including reconstructing the schedule of on-site service assigned to the extracted repair worker based on a destination location and a visit date and time.

10. A storage medium storing a repair worker assisting program executed by a server that assists dispatch of a repair worker who performs a maintenance task upon receiving a request for maintenance from an apparatus, the program causing a computer to execute:
receiving repair content data inputted from an apparatus of a customer;
calculating a repair fee based on the repair content data;
judging whether or claim a repair component is necessary based on the repair content data;
upon judging that the repair component is necessary in the preceding step, notifying an apparatus on a side of a deliverer who delivers the repair component of an instruction for delivering the repair component to the customer;
after delivering the repair component to the customer, receiving a notification of completion of delivery from the deliverer;
upon receiving the notification, notifying the apparatus of the customer of billing of the repair fee;
after the customer has paid the repair fee into a predetermined financial institute, receiving a notification of completion of payment from an apparatus on a side of the financial institute; and
upon receiving the notification of completion of payment, instructing to dispatch a repair worker to the customer's residence.

11. A storage medium according to claim 10, the program causing the computer to execute:
receiving an input of address data of the customer's residence;
referencing map data containing a position of a station located for each area; and
extracting an appropriate station based on the address data.

12. A storage medium storing s repair worker assisting program which, after a computer executes extracting a station, causes an apparatus to execute:
receiving an instruction for dispatching a repair worker from a server that assists dispatch of a repair worker who performs a maintenance task;
referencing a database that serves to manage a current location of the repair worker;
extracting an appropriate repair worker based on address data of a customer's residence to be visited; and
notifying a mobile apparatus owned by the repair worker of a dispatch instruction.

13. A storage medium storing a repair worker assisting program according to claim 12, the program comprising:
upon receiving an instruction for dispatching a repair worker from the server, referencing a database that serves to manage a scheduled visit number for each repair worker and the assigned number of repair workers for each area;
calculating an average number of visits in charge per repair worker from the scheduled visit number for repair workers and the assigned number of workers for each area; and
issuing a dispatch instruction in order from the repair workers in an area with a small average number of visits in charge per repair worker.

14. A storage medium storing a repair worker assisting program according to claim 12, including a step of, based on a location of the repair worker, a location of the customer's residence to be visited, and predetermined conditions, retrieving a route to the customer's residence in a chronological order for the visit time.

15. A storage medium storing a repair worker assisting program according to claim 14, in which, in the case where it is impossible to be in time for the visit time with a calculated route in the preceding step, an instruction for requesting an adjacent station to issue a dispatch instruction is issued from the mobile apparatus of the repair worker.

16. A storage medium according to claim 12, the program comprising:
receiving a sudden request for on-site repair from a customer;
referencing a database storing a schedule assigned to each repair worker; and
extracting a repair worker having much time left in his/her schedule.

17. A storage medium according to claim 16, the program further comprising: when the repair worker receives the request, reconstructing the schedule of on-site service assigned to the repair worker is executed based on a destination location and a visit date and time.

18. A repair worker assisting apparatus which assists dispatch of a repair worker who visits a customer's residence to perform a maintenance task upon receiving a request for maintenance from an apparatus, the system comprising:
a unit that receives repair content data inputted from the apparatus;
a unit that calculates a repair fee based on the repair content data;
a unit that judges whether or claim a repair component is necessary based on the repair content data;
a unit that, upon judging that the repair component is necessary in the preceding step, notifies an apparatus on a side of a deliverer who delivers the repair component of an instruction for delivering the repair component to a customer;
a unit that, after delivering the repair component to the customer, receives a notification of completion of delivery from the deliverer;
a unit that, upon receiving the notification, notifies the apparatus of the customer of billing of the repair fee;
a unit that, after the customer has paid the repair fee into a predetermined financial institute, receives a notification of completion of payment from a apparatus on a side of the financial institute; and
a unit that, upon receiving the notification of completion of payment, issues an instruction for dispatching a repair worker to the customer's residence.

19. An apparatus, comprising:
a unit that receives an instruction for dispatching a repair worker from a server that assists dispatch of a repair worker who performs maintenance tasks upon receiving a request for maintenance from an apparatus;
a unit that references a database that serves to manage a current location of the repair worker;
a unit that extracts an appropriate repair worker based on address data of a customer's residence to be visited; and
a unit that notifies a mobile apparatus owned by the repair worker of a dispatch instruction.

20. An apparatus according to claim 19, comprising:
a unit that receives an instruction for dispatching a repair worker from the server;
a unit that references a database that serves to manage a scheduled visit number for each repair worker and the assigned number of repair workers for each area;
a unit that calculates an average number of visits in charge per repair worker from the scheduled visit number for repair workers and the assigned number of workers for each area; and
a unit that issues a dispatch instruction in order from the repair workers in an area with a small average number of visits in charge per repair worker.

21. An apparatus according to claim 19, including a unit that, based on a location of the repair worker, a location of the customer's residence to be visited, and predetermined conditions, retrieves a route to the customer's residence in a chronological order for the visit time.

22. An apparatus according to claims 19 to 21, comprising:
a unit that receives a sudden request for on-site repair from a customer;
a unit that references a database storing a schedule assigned to each repair worker; and
a unit that extracts a repair worker having much time left in his/her schedule.

23. An apparatus according to claim 22, including a unit that, when the repair worker receives the request, reconstructs the schedule of on-site service assigned to the repair worker is executed based on a destination location and a visit date and time.
